(19) United States
(12) Patent Application Publication
(10) Pub. No.: US 2021/0281748 A1
(43) Pub. Date: Sep. 9, 2021

(54) INFORMATION PROCESSING APPARATUS

(71) Applicant: CANON KABUSHIKI KAISHA, Tokyo (JP)

(72) Inventors: Atsushi Nogami, Kanagawa (JP); Yusuke Mitarai, Tokyo (JP); Masakazu Matsugu, Kanagawa (JP)

(21) Appl. No.: 17/327,892

(22) Filed: May 24, 2021

Related U.S. Application Data
(63) Continuation of application No. PCT/JP2019/042487, filed on Oct. 30, 2019.

(30) Foreign Application Priority Data
Nov. 27, 2018 (JP) 2018-221559
Dec. 14, 2018 (JP) 2018-234704

(51) Int. Cl. H04N 5/232; G06T 7/80; G06T 7/00; G06K 9/62; G06F 16/53; G06N 20/00

(52) U.S. Cl. CPC H04N 5/23222; G06T 7/80; G06T 7/0002; H04N 5/23216; G06F 3/0482; G06K 9/6215; G06F 16/53; G06N 20/00; G06T 2207/30168; H04N 5/232939

(57) ABSTRACT

An information processing apparatus comprising: an acquisition unit configured to acquire reference data from a storage unit; an evaluation unit configured to evaluate, using the reference data acquired from the storage unit and each of a plurality of captured images obtained by capturing an image capturing target by each of a plurality of image capturing methods by an image capturing unit, appropriateness of each of the plurality of captured images as an execution target of processing of detecting a predetermined target from an image by a detection unit; and an estimation unit configured to estimate an image capturing method suitable for capturing the image capturing target based on an evaluation result of the evaluation unit.

### CROSS-REFERENCE TO RELATED APPLICATIONS

This application is a Continuation of International Patent Application No. PCT/JP2019/042487, filed Oct. 30, 2019, which claims the benefit of Japanese Patent Application No. 2018-221559, filed Nov. 27, 2018, and Japanese Patent Application No. 2018-234704, filed Dec. 14, 2018, both of which are hereby incorporated by reference herein in their entirety.

### BACKGROUND OF THE INVENTION

### Field of the Invention

The present invention relates to an information processing apparatus.

### Background Art

When inspecting a concrete wall surface of a structure such as a bridge, a dam, or a tunnel, an inspection engineer approaches the concrete wall surface and visually checks a variation such as a crack. Since such inspection work called close visual inspection is high in working cost, inspection by a method of automatically detecting a variation from an image obtained by capturing the concrete wall surface has been proposed in recent years. PTL 1 discloses a technique for detecting a crack from an image of a concrete wall surface using wavelet transformation.

To confirm aging such as extension of a crack, it is necessary to perform inspection every few years and comparison with a past inspection result. To capture an image in which a hardly visible crack such as a fine crack can be confirmed, it is necessary to appropriately set an image capturing parameter such a focus or exposure. However, a fine crack or the like can or cannot automatically be detected depending on a subtle difference in image capturing parameter. Therefore, it is necessary to finely adjust the image capturing parameter, thereby making it difficult to adjust the image capturing parameter.

To cope with this, PTL 2 discloses a method of adjusting an image capturing parameter. In PTL 2, a plurality of images are captured using a plurality of different image capturing parameters, and then displayed on a display. A user selects, from the plurality of images, an image which is determined as a most preferable image. As a result, the image capturing parameter which has been used to capture the selected image is set.

### CITATION LIST

### Patent Literature

PTL 1: Japanese Patent Laid-Open No. 2014-228357
PTL 2: Japanese Patent No. 4534816

### Non Patent Literature

NPL 1: Chopra, Sumit, Raia Hadsell, and Yann LeCun. “Learning a similarity metric discriminatively, with application to face verification.” Computer Vision and Pattern Recognition, 2005. CVPR 2005. IEEE Computer Society Conference on. Vol. 1. IEEE, 2005.
NPL 2: Xie, Junyuan, Linli Xu, and Enhong Chen. “Image denoising and inpainting with deep neural networks.” Advances in Neural Information Processing Systems. 2012.
NPL 3: Dong, Chao, et al. “Image super-resolution using deep convolutional networks.” IEEE transactions on pattern analysis and machine intelligence 38.2 (2016): 295-307.
NPL 4: Goodfellow, Ian, et al. “Generative adversarial nets.” Advances in neural information processing systems. 2014.
NPL 5: Gatys, Leon A., Alexander S. Ecker, and Matthias Bethge. “Image style transfer using convolutional neural networks.” Proceedings of the IEEE Conference on Computer Vision and Pattern Recognition. 2016.

However, in structure inspection, an image capturing parameter is finely adjusted. Thus, if the method described in PTL 2 is applied to structure inspection, a plurality of images having small differences therebetween are displayed. It is difficult for the user to compare images having small differences and select an optimum image. Furthermore, since images are captured outdoors, it is difficult to determine subtle differences between the images because of the influence of external light, a usable display size, or the like.

The present invention provides a technique for estimating an image capturing method suitable for capturing an image capturing target without requiring the user to confirm a captured image.

### SUMMARY OF THE INVENTION

According to one aspect of the present invention, there is provided an information processing apparatus comprising: an acquisition unit configured to acquiring reference data from a storage unit; an evaluation unit configured to evaluating, using the reference data acquired from the storage unit and each of a plurality of captured images obtained by capturing an image capturing target by each of a plurality of image capturing methods by an image capturing unit, appropriateness of each of the plurality of captured images as an execution target of processing of detecting a predetermined target from an image by a detection unit; and an estimation unit configured to estimating an image capturing method suitable for capturing the image capturing target based on an evaluation result of the evaluation unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram showing the arrangement of an information processing apparatus according to an embodiment;

FIG. 2 is a view for explaining an inspection target structure, its drawing, and an image capturing range:

FIG. 3 is a flowchart illustrating the procedure of processing performed by the information processing apparatus according to the first embodiment:

FIG. 4A is a view for explaining a plurality of image capturing parameters;

FIG. 4B is a view for explaining a plurality of image capturing parameters;

FIG. 5A is a view for explaining past data and a detection result of a target;

FIG. 5B is a view for explaining past data and a detection result of a target:

FIG. 5C is a view for explaining the past data and the detection result of the target;

FIG. 6A is a view for explaining an overview of an evaluation value;

FIG. 6B is a view for explaining an overview of an evaluation value:

FIG. 6C is a view for explaining an overview of an evaluation value:

FIG. 7 is a view for explaining an example of a practical calculation method of the evaluation value;

FIG. 8A is a view for explaining evaluation value calculation using a crack changed after past inspection;

FIG. 8B is a view for explaining evaluation value calculation using the crack changed after the past inspection;

FIG. 8C is a view for explaining evaluation value calculation using the crack changed after the past inspection;

FIG. 8D is a view for explaining evaluation value calculation using the crack changed after the past inspection;

FIG. 9A is a view for explaining evaluation of each image capturing parameter;

FIG. 9B is a view for explaining evaluation of each image capturing parameter;

FIG. 10 is a view showing an example of display contents of an operation unit;

FIG. 11 is a view for explaining a plurality of image capturing ranges according to the third embodiment:

FIG. 12 is a view for explaining an example of an appearance test according to the fifth embodiment:

FIG. 13 is a block diagram showing an example of the hardware arrangement of an information processing apparatus;

FIG. 14 is a block diagram showing an example of the arrangement of the information processing apparatus;

FIG. 15 is a view for explaining information stored in an image storage unit:

FIG. 16 is a flowchart illustrating an example of information processing;

FIG. 17 is a view showing an example of a screen at the time of an image search;

FIG. 18A is a view for explaining setting of image capturing parameters;

FIG. 18B is a view for explaining setting of image capturing parameters;

FIG. 19A is a view for explaining an evaluation value calculation method based on a partial image at a crack position;

FIG. 19B is a view for explaining the evaluation value calculation method based on a partial image at a crack position;

FIG. 20A is a view for explaining evaluation of each image capturing parameter;

FIG. 20B is a view for explaining evaluation of each image capturing parameter;

FIG. 21 is a view for explaining an operation unit when the image capturing parameter is adjusted;

FIG. 22 is a block diagram showing an example of the arrangement of an information processing apparatus according to the ninth embodiment; and

FIG. 23 is a view for explaining information stored in an image storage unit according to the 10th embodiment.

### DESCRIPTION OF THE EMBODIMENTS

Hereinafter, embodiments will be described with reference to the accompanying drawings. Note that arrangements to be described in the following embodiments are merely examples, and the present invention is not limited to the illustrated arrangements.

### First Embodiment

In the first embodiment, image capturing parameter adjustment in inspection of an image of an infrastructure will be exemplified. Examples of the infrastructure are a bridge, a dam, and a tunnel, and an image for image inspection is created by capturing the concrete wall surface of the structure. An image targeted by the embodiment is not limited to this, and an image targeting another structure or the surface of a material other than concrete may be used. For example, an inspection image may be created by setting a road as an inspection target and capturing an image of an asphalt surface.

The first embodiment assumes that the inspection target is a variation of the concrete wall surface. Examples of the variation of the concrete wall surface are a crack, efflorescence, a rock pocket, a cold joint, and reinforcement exposure. The first embodiment will particularly describe an example in which a crack is set as an inspection target.

An overview of this embodiment will be described first. Assume that a crack on a concrete wall surface is never recovered naturally unless it is repaired. Therefore, a crack recorded in a past inspection result should be observed on the current concrete wall surface. In this embodiment, based on this assumption, an image capturing parameter is adjusted so as to observe the crack of the past inspection result. This makes it possible to set the image capturing parameter for appropriately capturing the inspection target concrete wall surface. More specifically, crack detection processing is performed for each of images captured using a plurality of image capturing parameters, and the evaluation value of each image capturing parameter is calculated from each detection result and the past inspection result. Based on the evaluation values, the image capturing parameter is selected or a method of improving the image capturing parameter is estimated. A practical embodiment of this processing will be described below.

<Arrangement of Information Processing Apparatus>

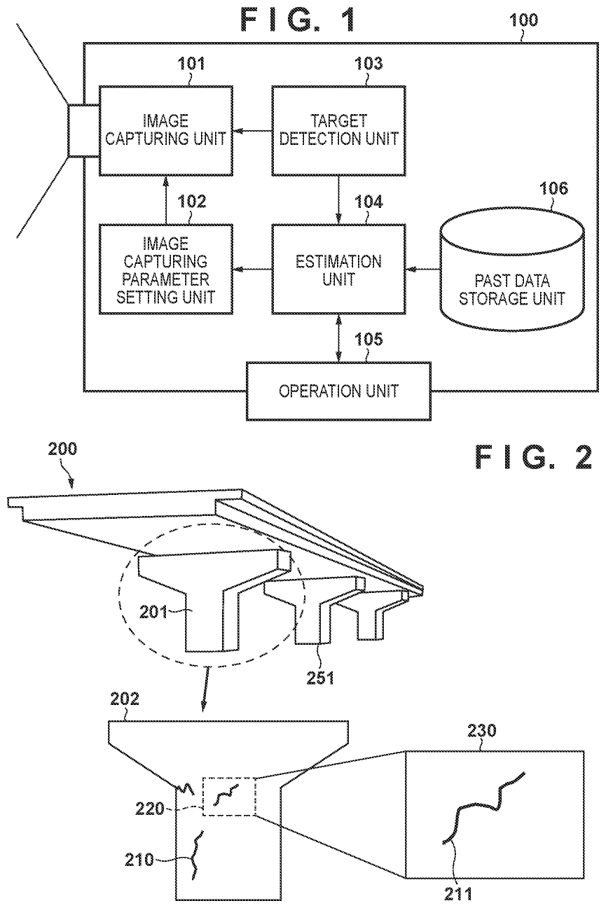

FIG. 1 is a block diagram showing an example of the arrangement of an information processing apparatus 100 according to the embodiment of the present invention. The information processing apparatus 100 can be implemented when a computer formed by a CPU, a memory, a storage device, an input/output device, a bus, a display device, and the like executes software (program) acquired via a network or various recording media. Note that as the computer, a general-purpose computer may be used or hardware designed to be optimum for software according to the present invention may be used. The information processing apparatus 100 may be integrated with an image capturing unit 101, as shown in FIG. 1, and included in the housing of a camera. Alternatively, the information processing apparatus 100 may be configured as a housing (for example, a notebook PC or tablet) different from a camera including the image capturing unit 101, which receives an image captured by the image capturing unit 101 and transmitted wirelessly or via a wire.

The information processing apparatus 100 includes the image capturing unit 101, an image capturing parameter setting unit 102, a target detection unit 103, an estimation unit 104, an operation unit 105, and a past data storage unit 106. The image capturing unit 101 captures an inspection target object. The image capturing parameter setting unit 102 sets an image capturing parameter used by the image capturing unit 101 to capture an image. The target detection unit 103 detects a crack or the like as an inspection target. The estimation unit 104 estimates a method of improving the image capturing parameter. The operation unit 105 presents necessary information to the user, and also accepts an operation input from the user. The past data storage unit 106 is a storage that stores a past inspection result.

The past data storage unit 106 will first be described in more detail. The past data storage unit 106 may be included in the information processing apparatus, as shown in FIG. 1, or a remote server may be used as the past data storage unit 106. If the past data storage unit 106 is formed by a server, the information processing apparatus 100 is made to be able to acquire, via the network, past data saved in the past data storage unit 106.

FIG. 2 is a view for explaining data stored in the past data storage unit 106. FIG. 2 shows a state in which past data of a bridge 200 as an inspection target object is stored. The past data storage unit 106 records a past inspection result in association with the drawing of the bridge 200. For example, with respect to a given pier 201 of the bridge 200, the position and shape of a crack 210 or the like are recorded as a past inspection result in a drawing 202. In the first embodiment, this inspection result is assumed as a result of capturing an image of the pier 201 at the time of a past inspection work, and performing detection by automatic detection processing of the target detection unit 103 (to be described later).

The past inspection result is not limited to this embodiment, and may be, for example, a result obtained by modifying, by a human, the result obtained by the automatic detection processing or a result recorded by close visual inspection by a human without intervention of the automatic detection processing. The information processing apparatus 100 can call an inspection result of an arbitrary portion of the inspection target structure from the past inspection result recorded in the past data storage unit 106. The past inspection result (in the first embodiment, the position and shape of a crack in an image) will be referred to as past data hereinafter.

FIG. 2 also shows the relationship between the image capturing range of the image capturing unit 101 and the past data to be called. In inspection by an image, to confirm a crack having a width of 1 mm or less, it is necessary to capture the concrete wall surface at a high resolution. To do this, in many cases, the entire wall surface of the pier or the like cannot be captured at once, and an image is captured a plurality of times while shifting an image capturing position, thereby creating a high-resolution image of the entire wall surface by connecting the images.

FIG. 2 shows, in the drawing 202 of the pier, an image capturing range 220 as an example of a range that can be captured by one image capturing operation. The whole pier 201 is captured by repeatedly, partially capturing the wall surface of the pier. In this embodiment, image capturing parameter adjustment is performed using past data included in a given image capturing range (for example, the image capturing range 220 shown in FIG. 2). Note that in capturing the pier 201, the whole pier 201 is captured with the image capturing parameter adjusted using the image capturing range 220 shown in FIG. 2.

The past data to be called from the past data storage unit 106 will be described next. The first embodiment assumes that the past data of the image capturing range is called as an image. FIG. 2 shows past data 230 called when capturing the image capturing range 220. The past data 230 is an image including a crack 211 and having the same size as that of an image captured by the image capturing unit 101. More specifically, the past data 230 is an image in which 1 is recorded in pixels at which the crack exists and 0 is recorded in the remaining pixels. The past data storage unit 106 generates an image of such past data when an arbitrary image capturing range is designated. In the description of the first embodiment, image data obtained by drawing the crack of the past inspection result in the image corresponding to the image capturing range will be referred to as past data hereinafter.

<Processing>

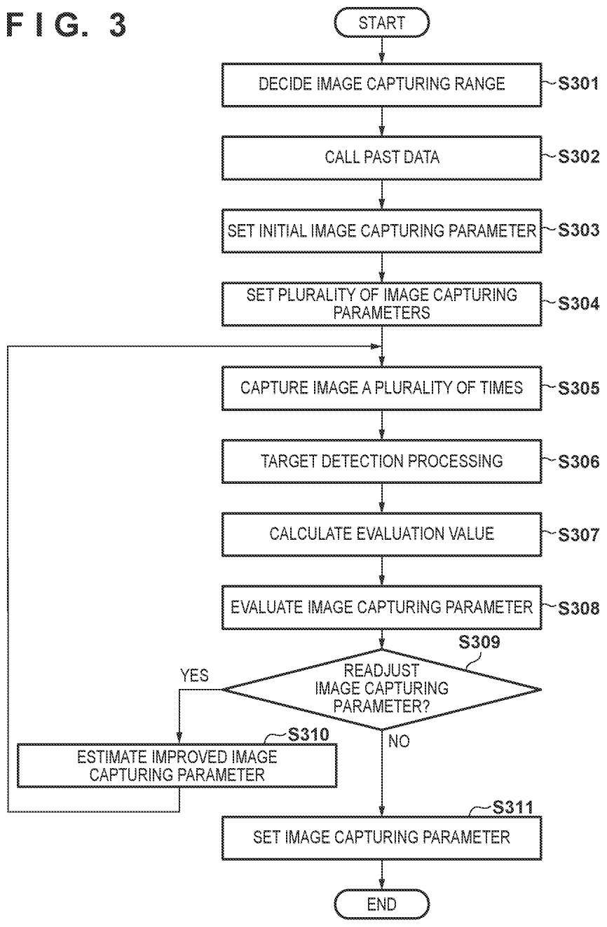

Subsequently, the procedure of processing executed by the information processing apparatus 100 according to this embodiment will be described with reference to a flowchart shown in FIG. 3.

[Step S301]

In step S301, the information processing apparatus 100 decides an image capturing range of an inspection target structure. For example, a method of deciding an image capturing range is performed, as follows. The first method is a method of designating an image capturing range from a drawing by the user. For example, if the pier 201 shown in FIG. 2 is inspected, the drawing 202 is displayed on the display unit of the operation unit 105, and the user designates the image capturing range 220 of the drawing. At this time, the user selects, as the image capturing range, a region including the crack of the past inspection result. If the past inspection result of the image capturing range designated by the user includes no crack, the information processing apparatus 100 notifies the user of a warning to prompt the user to reset the image capturing range.

After designating the image capturing range, the user adjusts the position and orientation of the image capturing unit 101 with respect to the actual pier 201 so as to capture the designated image capturing range. To assist the user to perform an operation of selecting the image capturing range, the position of the crack of the past inspection result may be displayed on the drawing displayed to decide the image capturing range. Alternatively, information such as an ID may be added to the crack recorded in the past data storage unit 106, thereby allowing the user to readily search for or select an arbitrary region including the crack.

For example, if the user inputs, to the operation unit 105, the ID of the crack included in the image capturing range, the crack of the ID is selected from the past data storage unit 106. Then, the region including the crack is automatically set as the image capturing range. In this example, the example of using the ID to search for the crack has been explained. However, the method of searching for a crack is not limited to this, and a crack may be searched for by using information such as the coordinates of the crack. This allows the user to readily set an image capturing range including a specific crack.

The second method of the method of deciding the image capturing range is an embodiment in which the information processing apparatus 100 recommends the image capturing range to the user. Since the image capturing parameter is adjusted using the past inspection result, the image capturing range needs to include the past inspection result. Therefore, the information processing apparatus 100 selects the image capturing range including the past inspection result of the inspection target structure, and recommends it as the image capturing range to the user. The recommendation of the image capturing range is displayed like the image capturing range 220 in the drawing, as shown in FIG. 2. The user confirms the recommended image capturing range, and adjusts the position and orientation of the image capturing unit 101 with respect to the actual pier 201 so as to capture the recommended image capturing range. As the image capturing range recommended by the information processing apparatus 100, not only one image capturing range but also a plurality of image capturing ranges may be presented to the user, and the user may be able to select the image capturing range to be actually captured.

The image capturing range to be preferentially recommended may be decided in accordance with the crack of the past inspection result. For example, a region including an important thick crack or a crack occurring at a structurally important position in the past inspection result may be preferentially recommended as the image capturing range. On the other hand, since a crack repaired after the past inspection can no longer be observed, it is not preferable to set, as the image capturing range, a range including the repaired crack. Therefore, if information of execution of repair is recorded together with the past inspection result, that portion is prevented from being selected as the image capturing range.

In the above-described embodiment, the user adjusts the position and orientation of the image capturing unit 101 with respect to the actual structure. However, the adjustment by the user may be supported using a sensor for measuring the position and orientation of the image capturing unit 101. For example, when adjusting the position and orientation of the image capturing unit 101 toward the image capturing range selected by the user or recommended by the information processing apparatus 100, the user is notified, based on the position and orientation of the image capturing unit 101 measured by the sensor, of a method of adjusting the position and orientation of the image capturing unit 101 to those at which the target image capturing range can be captured.

As the sensor for measuring the position and orientation of the image capturing unit 101, there are provided various methods such as an acceleration sensor, a gyro sensor, and a GPS but any of them may be used. The position and orientation of the image capturing unit 101 may be determined by determining, from the image being captured by the image capturing unit 101, a portion of the target structure being captured, instead of the sensor. As for these methods of obtaining the position and orientation of the image capturing unit 101, existing methods are used and a detailed description thereof will be omitted.

Furthermore, if an arrangement for measuring the position and orientation of the image capturing unit 101 is provided, the image capturing range may be decided from the position and orientation of the image capturing unit 101. In this case, the user directs the image capturing unit 101 to the actual inspection target structure. Then, the position and orientation of the image capturing unit 101 is measured and a portion of the inspection target structure being captured is set as the image capturing range.

The above embodiment has explained the arrangement for deciding the position and orientation of the image capturing unit 101 by operating the image capturing unit 101 by the user. However, the information processing apparatus 100 including the image capturing unit 101 may be set on an automatic platform, and the platform may automatically move so that the image capturing unit 101 takes the orientation for capturing the predetermined image capturing range. Alternatively, for example, the information processing apparatus 100 may be set on a moving body such as a drone, and controlled to take the position and orientation for capturing the predetermined image capturing range.

In step S301 described above, the image capturing range of the inspection target structure is decided, and the image capturing unit 101 takes the position and orientation for capturing the image capturing range.

[Step S302]

In step S302 of FIG. 3, the information processing apparatus 100 calls past data corresponding to the image capturing range from the past data storage unit 106. This past data is image data obtained by drawing the crack included in the image capturing range, as described with reference to FIG. 2.

[Step S303]

In step S303, the information processing apparatus 100 decides the initial value (to be referred to as an initial image capturing parameter hereinafter) of the image capturing parameter. To set the initial image capturing parameter, for example, an image capturing parameter when capturing the same position in the past is recorded in the past data storage unit 106, and is then called and set as the initial image capturing parameter. Alternatively, the image capturing parameter decided by the normal image capturing parameter adjustment method (automatic parameter adjustment) of the image capturing apparatus may be set as the initial parameter.

[Step S304]

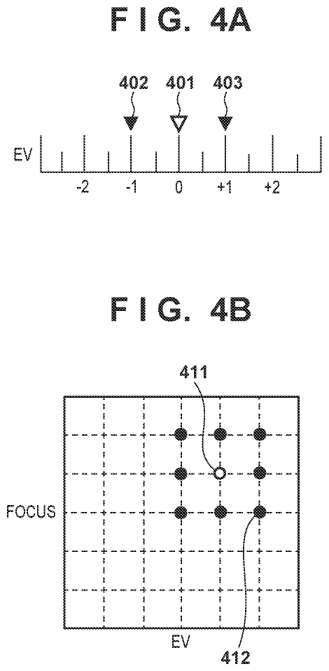

In step S304, the information processing apparatus 100 sets a plurality of image capturing parameters using the image capturing parameter setting unit 102 based on the initial image capturing parameter. FIGS. 4A and 4B each show a state in which the plurality of image capturing parameters are set based on the initial image capturing parameter. FIG. 4A is a view for explaining an embodiment of adjusting an exposure (EV) as an example of the image capturing parameter to be adjusted. Referring to FIG. 4A, a state in which EV0 is set as the initial parameter is indicated by a white triangle 401. The image capturing parameter setting unit 102 sets the plurality of image capturing parameters by centering this initial parameter.

In FIG. 4A, EV−1 (a black triangle 402 shown in FIG. 4) and EV+1 (a black triangle 403 shown in FIG. 4A) are set as the plurality of parameters by changing the exposure by one step by centering EV0. This example shows a state in which the three image capturing parameters including the initial image capturing parameter are set. However, the number of image capturing parameters to be set is not limited to this. For example, exposures different by two steps may further be set, thereby setting the five image capturing parameters in total. In addition, in this example, the plurality of image capturing parameters are set in accordance with the rule of changing the exposure by one step. However, the change step of the image capturing parameter may be set by other setting methods. For example, the exposure may be set by a step of ½, or randomly set around the initial image capturing parameter.

The embodiment in which the image capturing parameter indicates the exposure (EV) has been described above but the image capturing parameter to be set is not limited to the exposure. Any image capturing parameter may be used as long as it is used to control the image capturing unit 101. Examples of the image capturing parameter are a focus, a white balance (color temperature), a shutter speed, a stop, an ISO sensitivity, and the saturation and tone of an image.

The embodiment in which only the exposure is set as the image capturing parameter to be adjusted has been explained with reference to FIG. 4A. However, a plurality of image capturing parameters may be adjusted simultaneously. For example, FIG. 4B is a view for explaining an embodiment in which a combination of the exposure and focus is set as an image capturing parameter to be adjusted. In FIG. 4B, a combination of given exposure and focus is set as an initial parameter, which is indicated by a white circle 411. Combinations of image capturing parameters indicated by black circles 412 are set as a plurality of image capturing parameters by centering the initial parameter.

Note that the combination of image capturing parameters to be adjusted is not limited to the combination of the exposure and focus shown in FIG. 4B, and may be a combination of other image capturing parameters. Furthermore, the embodiment of adjusting the combination of two parameters has been explained above. However, the number of image capturing parameters is not limited to this, and a combination of three or more image capturing parameters may be adjusted simultaneously.

As described above, the image capturing parameter setting unit 102 sets the plurality of image capturing parameters. An embodiment in which an image capturing parameter to be adjusted is an exposure, as shown in FIG. 4A, will be described below.

[Step S305]

Subsequently, in step S305, the information processing apparatus 100 captures the image capturing range of the inspection target object by the image capturing unit 101 using the plurality of image capturing parameters set in step S304. More specifically, if the three exposures are set, as shown in FIG. 4A, three images are captured while changing the exposure.

[Step S306]

In step S306, the information processing apparatus 100 executes, for the plurality of images captured in step S305, target detection processing using the target detection unit 103. In this embodiment, since the target is a crack, crack detection processing is executed for each image. As a method of detecting a crack from an image, for example, a method disclosed in PTL 1 is used. The method of detecting a crack is not limited to the method disclosed in PTL 1. For example, a method of learning in advance the image feature of a crack from an image in which the position and shape of the crack are known and detecting the position and shape of the crack of an input image based on the learning result may be used. The crack detected in step S306 will be referred to as a detection result hereinafter.

Processing in step S307 and subsequent steps of FIG. 3 is processing executed mainly by the estimation unit 104, and is processing of selecting an optimum image capturing parameter or processing of further searching for an optimum image capturing parameter.

[Step S307]

In step S307, the information processing apparatus 100 calculates an evaluation value for each of the plurality of image capturing parameters using the estimation unit 104. The evaluation value is higher as the image capturing parameter is more suitable for capturing an inspection image. The evaluation value is calculated by comparing, with the crack of the past data, the detection result of the crack for each of the images captured using the plurality of image capturing parameters.

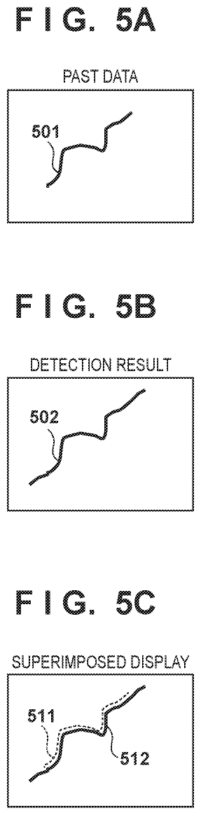

To describe step S307, FIG. 5A to 5C show examples of the past data and the detection result. FIG. 5A shows the past data of the image capturing range, which includes a crack 501 as the past inspection result. FIG. 5B shows the detection result of performing the crack detection processing for the image captured using a given image capturing parameter, in which a crack 502 is detected. In FIG. 5C, the past data shown in FIG. 5A and the detection result shown in FIG. 5B are superimposed and displayed, in which the crack of the past data is represented by a broken line 511 and the crack of the detection result is represented by a solid line 512. Ideally, the crack 511 of the past data and the crack 512 of the detection result completely overlap each other but are shifted from each other and displayed for the sake of illustrative convenience.

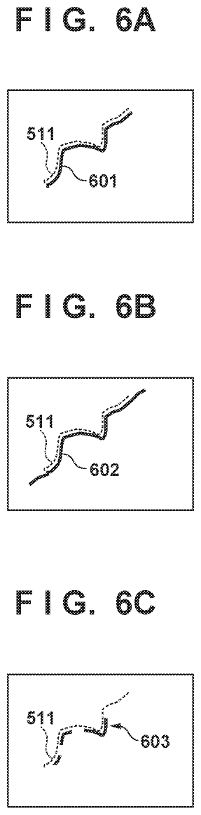

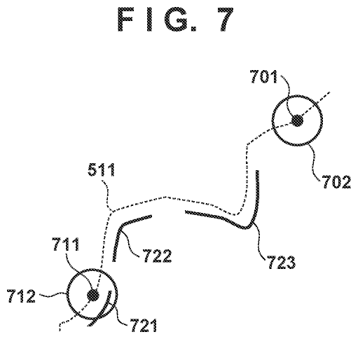

An overview of the evaluation value will be described next with reference to FIGS. 6A to 6C. FIGS. 6A to 6C are views in which cracks 601, 602, and 603 of the detection results of the different captured images are superimposed and displayed on the crack 511 of the same past data, respectively.

FIG. 6A shows a case in which the crack 511 of the past data matches the crack 601 of the detection result. This case indicates that the image from which the past inspection result can completely, automatically be detected can be captured. Therefore, this image capturing parameter is suitable, and an evaluation value s_{A} in the case shown in FIG. 6A is high.

FIG. 6B shows a case in which the crack 602 of the detection result is longer than the crack 511 of the past data. Since the crack extends due to aging, the phenomenon in which the current crack is longer than the past inspection result can occur. Therefore, in the case shown in FIG. 6B, the image from which it is possible to confirm the past crack can be captured, and it is thus considered that the image capturing parameter is suitable for capturing an inspection image. Thus, an evaluation value S_{B} in the case shown in FIG. 6B is also high. Assuming that the crack almost certainly extends due to aging, it can be considered that the case in which the extended crack can be detected, as shown in FIG. 6B, is more appropriate than the case in which the detection result completely matches the past data, as shown in FIG. 6A. Therefore, the evaluation values s_{A} and S_{B} are both high but the evaluation value s_{B} may be set higher.

As described above, the evaluation value has a high value when the crack of the detection result matches the crack of the past data or when the crack of the detection result extends over a larger region including the crack of the past data.

On the other hand, FIG. 6C shows a case in which the crack 603 of the detection result is only partially obtained with respect to the crack 511 of the past data. The crack recorded in the past never disappears unless it is repaired. Therefore, since the image capturing parameter for capturing the image from which the entire crack 511 of the past data cannot be detected is not suitable as the image capturing parameter for an inspection image, an evaluation value s_{C} in the case shown in FIG. 6C is low. In the case shown in FIG. 6C, to obtain the image capturing parameter, whose evaluation value is high and which is suitable for capturing an inspection image, by further adjusting the image capturing parameter, it is necessary to further perform adjustment. In summary, the evaluation values in the respective cases shown in FIGS. 6A-6C have a relationship given by;

s_{B}≥s_{A}>s_{C} (1)

A practical method of calculating an evaluation value s will be described next with reference to FIG. 7. FIG. 7 is a view obtained by enlarging FIG. 6C, in which the crack of the past data is represented by the broken line 511 and detection results 721 to 723 are represented by solid lines. In the method of calculating the evaluation value s in this example, respective pixels on the crack 511 of the past data are associated with the detection results 721 to 723, and the evaluation value s is calculated based on the number of corresponding pixels. For example, the crack of the past data is associated with that of the detection result, as follows.

First, a pixel 701 shown in FIG. 7 is a given pixel on the crack 511 of the past data. If a predetermined peripheral range 702 of the pixel 701 is searched and the crack of the detection result exists, it is determined that the pixel 701 can be associated with the detection result. Note that the predetermined peripheral range 702 is defined as, for example, a range of 5 pixels at the center of the pixel 701. In the example shown in FIG. 7, since the crack of the detection result is not included in the peripheral range 702 of the pixel 701, the pixel 701 is a pixel that cannot be associated with the detection result. On the other hand, with respect to another pixel 711 on the crack 511 of the past data, a peripheral range 712 of the pixel 711 includes the crack 721 of the detection result, and thus the pixel 711 is a pixel that can be associated with the detection result. This determination processing is repeated for pixels on the one crack of the past data, thereby calculating the evaluation value s based on the one crack. At this time, the evaluation value s is given by:

$$s = \frac{1}{p ( C )} {\sum }_{i ∈ C} {f}_{i} \qquad ( 2 )$$

where C represents a crack of given past data and p(C) represents the number of pixels of the crack C. Furthermore, i represents a pixel on the crack C, and fᵢ is set to 1 when the pixel i can be associated with the detection result, and is set to 0 when the pixel i cannot be associated with the detection result.

Note that equation (2) indicates the method of calculating the evaluation value s based on one crack of given past data. If a plurality of cracks of the past data fall within the image capturing range, with respect to the evaluation value s, the evaluation value is calculated by equation (2) for each crack and the sum or average of the evaluation values is set as the final evaluation value.

When the evaluation values s_{A} and s_{B} in FIGS. 6A and 6B are calculated by the method indicated by equation (2).

s_{A}=s_{B}=1 (3)

The highest evaluation values are respectively output. If it is determined, in consideration of aging from the past crack, that the case in which the extended portion can also be detected, as shown in FIG. 6B, is better than a case in which the detection result completely matches the past data, as shown in FIG. 6A, the evaluation value calculation method that gives s_{B}>s_{A} is needed. To do this, for example, the evaluation value is calculated after the crack end point of the past data is extended by a predetermined number of pixels in a direction in which the crack is expected to extend.

Note that if it is considered that aging of the crack is only extension of the crack, the evaluation value is calculated, as described above. However, the appearance of the crack may largely change due to aging. For example, if a lime component of concrete is deposited from the crack, the lime component may be solidified on the concrete surface to cover the crack. If deposition (to be referred to as efflorescence hereinafter) of the lime component occurs, the crack cannot be confirmed completely from the appearance, and only the region of efflorescence is confirmed. In this way, it is impossible to detect the crack similar to that of the past data from an image obtained by capturing the crack which has largely changed from the past inspection result. Therefore, as described above, in the method of associating the crack with that of the past data, it is impossible to correctly calculate the evaluation value for selecting the image capturing parameter.

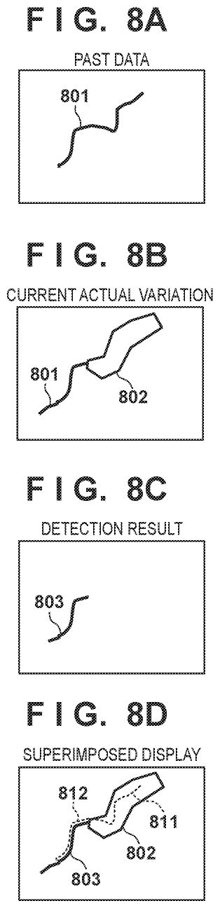

To cope with this problem, the target detection unit 103 may detect not only the crack but also efflorescence, thereby limiting an evaluation value calculation region based on the crack of the past data. FIGS. 8A to 8D are views for explaining this processing. FIG. 8A shows past data. FIG. 8B shows the current actual state of the concrete wall surface which is the same as that of the past data, and shows a state in which efflorescence 802 occurs from a crack 801 due to aging. The efflorescence 802 occurs to cover part of the crack observed in the past data. FIG. 8C shows a detection result of performing crack detection, by the target detection unit 103, for an image obtained by capturing the concrete wall surface shown in FIG. 8B using a given image capturing parameter. On the concrete wall surface shown in FIG. 8B, a crack in the region where the efflorescence 802 appears cannot be seen. Thus, in the detection result shown in FIG. 8C, only part of the crack of the past data is detected.

FIG. 8D is a view in which cracks 811 and 812 of the past data represented by broken lines and a crack 803 of the detection result represented by a solid line are superimposed and displayed. FIG. 8D also shows the region 802 of the efflorescence detected by the target detection unit 103. Among the broken lines representing the cracks of the past data, the broken line 811 indicates a portion overlapping the region 802 of the efflorescence, and the broken line 812 indicates a portion not overlapping the efflorescence. In this status, the evaluation value is calculated based on the crack 803 of the detection result and the crack 812 as the portion not overlapping the efflorescence among the cracks of the past data. That is, the evaluation value is calculated by excluding the region where predetermined aging (efflorescence) is detected.

As the evaluation value calculation method, calculation can be performed by the above-described method of associating pixels with each other using the crack 812 of the past data and the crack 803 of the detection result. This makes it possible to calculate the evaluation value of the image capturing parameter using the crack whose appearance has changed due to the occurrence of the efflorescence after the past inspection.

Note that in this embodiment, the factor for changing the appearance of the crack is efflorescence. However, other factors for changing the appearance of the crack are also considered. For example, as the deterioration of the crack progresses, the surface of the crack peels or flakes. In this state, the crack may largely change in appearance from the crack at the time of the past inspection. Therefore, similar to the case of efflorescence, a region where predetermined aging such as peeling or flaking occurs may be detected and excluded from the evaluation value calculation region based on the crack of the past data.

Furthermore, the appearance of the crack at the time of the past inspection may completely change. For example, the entire crack may be covered with efflorescence due to aging. In the image capturing region including the crack whose appearance has completely changed, comparison with the past crack cannot be performed, and it is thus impossible to perform image capturing parameter adjustment. Therefore, if it is determined that the appearance of the crack has completely changed, for example, efflorescence that makes the crack of the past data disappear is detected, image capturing parameter adjustment within the current image capturing range may be aborted. In this case, the information processing apparatus 100 recommends, as the image capturing range, another region of the concrete wall surface including the past data.

In step S307, as described above, the evaluation value is calculated for each of the plurality of image capturing parameters.

[Steps S308 to S311]

In step S308, the information processing apparatus 100 evaluates the image capturing parameter based on the evaluation values calculated in step S307. In step S309, the information processing apparatus 100 determines, based on the evaluation results, whether to readjust the image capturing parameter. If the image capturing parameter is readjusted, the process advances to step S310; otherwise, the process advances to step S311. In step S310, the information processing apparatus 100 estimates a method of improving the image capturing parameter. After that, the process returns to step S305. In step S311, the information processing apparatus 100 sets the image capturing parameter. Then, the series of processes of image capturing parameter adjustment ends. These processes will be described in detail below.

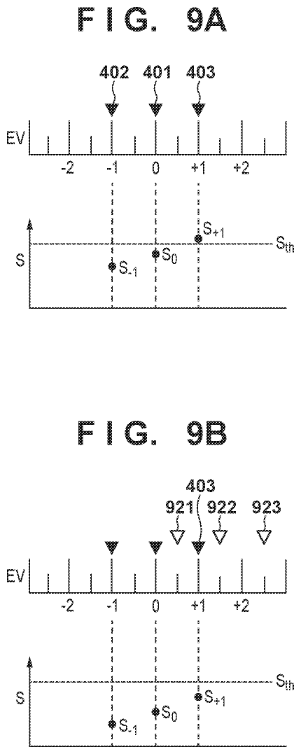

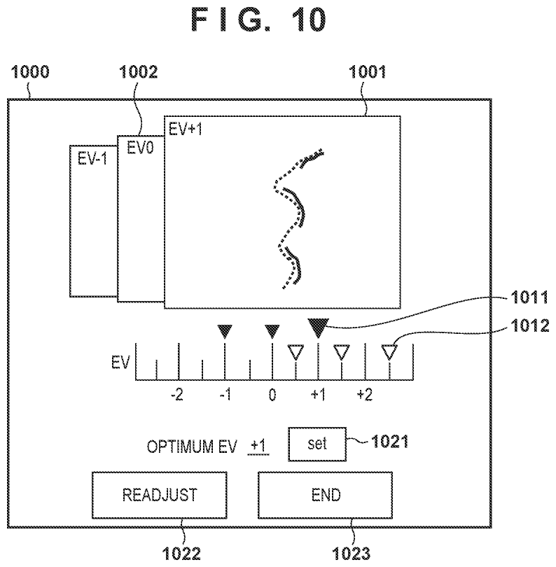

In the image capturing parameter evaluation processing in step S308, a highest one of the evaluation values of the plurality of image capturing parameters is selected and compared with a predetermined threshold. FIG. 9A is a view for explaining evaluation of each image capturing parameter. In this embodiment, as the plurality of image capturing parameters, the three exposures (EV) are set. In FIG. 9A, states in which EV−1, EV0, and EV+1 are set as the plurality of image capturing parameters are represented by the triangles 401, 402, and 403, similar to FIG. 4A. The lower portion of FIG. 9A shows evaluation values s₋₁, s₀, and s₊₁ obtained from the detection results of the images captured using the respective image capturing parameters. In FIG. 9A, the evaluation value s₊₁ of the exposure 403 of EV+1 is the highest evaluation value and exceeds a predetermined threshold sₜₕ. If there exists the image capturing parameter indicating the evaluation value exceeding the predetermined threshold sₜₕ, it is determined that the image capturing parameter is suitable as an image capturing parameter for an inspection image.

In the case shown in FIG. 9A, the exposure 403 of EV+1 is selected as an optimum parameter, it is determined in step S309 that it is unnecessary to readjust the image capturing parameter, and the process advances to step S311 to set the image capturing parameter. In step S311, the exposure of EV+1 is set in the image capturing unit 101 via the image capturing parameter setting unit 102, thereby ending the processing.

On the other hand, FIG. 9B shows an example of setting EV−1, EV0, and EV+1 as the plurality of image capturing parameters and calculating evaluation values, similar to FIG. 9A, but shows a status in which the evaluation values different from those in FIG. 9A are obtained. In FIG. 9B, the evaluation value s₊₁ is the highest evaluation value but even s₊₁ does not exceed the predetermined threshold sₜₕ. In the images captured using these image capturing parameters, no detection results sufficiently matching the crack of the past data are obtained, and each of these image capturing parameters is not suitable as an image capturing parameter for an inspection image. In this case, it is determined in step S309 that it is necessary to readjust the image capturing parameter, and a method of improving the image capturing parameter is estimated in step S310.

Subsequently, estimation of the method of improving the image capturing parameter will be described with reference to FIG. 9B. In FIG. 9B, the evaluation value s₊₁ of the exposure of EV+1 is lower than the threshold sₜₕ but is the highest evaluation value among the evaluation values s₋₁ to s₊₁. Therefore, in the image capturing parameter readjustment processing, a plurality of image capturing parameters are set from peripheral image capturing parameters of the image capturing parameter (exposure of EV+1). For example, if three image capturing parameters are also set in the next image capturing parameter adjustment processing, exposures 921, 922, and 923 around the exposure 403 of EV+1 are set as a plurality of parameters, as shown in FIG. 9B. Then, the process returns to step S305, and the image capturing parameters are set in the image capturing unit 101 via the image capturing parameter setting unit 102 to capture a plurality of images again. The processes (target detection processing and evaluation value calculation processing) in step S306 and the subsequent steps of FIG. 3 are re-executed to search for an optimum image capturing parameter. If no evaluation value equal to or higher than the threshold sₜₕ is obtained even in evaluation of the image capturing parameter set, a plurality of new image capturing parameters are decided around the image capturing parameter indicating the highest evaluation value, and the image capturing processing is executed again. This loop is repeatedly executed until the image capturing parameter for which an evaluation value exceeding the threshold sₜₕ is obtained is decided.

Note that the maximum repetition count may be decided in advance, and if no optimum image capturing parameter (no image capturing parameter for which an evaluation value equal to or higher than the threshold sₜₕ is obtained) is obtained before the maximum repetition count, the processing may be aborted. If the image capturing parameter adjustment processing is aborted, a warning is displayed on the display unit of the operation unit 105 to notify the user that the image capturing parameter is not sufficiently adjusted. Alternatively, the image capturing parameter for capturing the image, for which the highest evaluation value is calculated and which is obtained before the processing is aborted, may be set in the image capturing unit 101 via the image capturing parameter setting unit 102.

The embodiment in which if no evaluation value equal to or higher than the threshold sₜₕ is obtained in step S308, estimation of improved image capturing parameters and repetitive adjustment are performed has been explained above. However, even if the image capturing parameter indicating the evaluation value equal to or higher than the threshold sₜₕ is found, an image capturing parameter indicating a higher evaluation value may further be searched for. In this case, after setting, as improved image capturing parameters, image capturing parameters around the image capturing parameter indicating the highest evaluation value, a plurality of images are captured again, and the crack detection processing and evaluation value calculation processing are repeatedly executed. As a condition for ending the repetitive processing, a predetermined repetition count is reached or the evaluation value remains unchanged even if the image capturing parameter is changed around the highest evaluation value.

The processing of adjusting the image capturing parameter by performing the loop described above may automatically repeat capturing and evaluation of a plurality of images and next parameter estimation. In this case, the image capturing unit 101 is fixed to a tripod or the like, and the user stands by until image capturing parameter adjustment is completed.

On the other hand, the user may confirm the image capturing parameter and the detection result, and then determines to end the repetitive processing for image capturing parameter adjustment. In this case, in step S30) of FIG. 3, the processing of determining the optimum image capturing parameter using the threshold sₜₕ of the evaluation value is not performed, and the user determines whether to execute image capturing parameter readjustment. To do this, the operation unit 105 presents necessary information to the user, and also accepts an input from the user. FIG. 10 is a view for explaining a display unit 1000 as an example of the operation unit 105 when performing image capturing parameter adjustment by user determination. Information presented to the user and a user operation will be described below with reference to FIG. 10.

The display unit 1000 shown in FIG. 10 is a display for displaying information. For example, if the information processing apparatus 100 is an image capturing apparatus including the image capturing unit 101, the display unit 1000 is a touch panel display provided on the rear surface of the image capturing apparatus. An image 1001 displayed on the display unit 1000 is an image obtained by superimposing and displaying the crack of the past data displayed by a dotted line and the crack of the detection result displayed by a solid line on an image captured using the image capturing parameter of EV+1. This example shows an example of displaying the cracks by the dotted line and the solid line.

As the method of displaying the cracks of the past data and the detection result, the cracks may be discriminated and displayed by different colors. An image 1002 hidden by the image 1001 is an image obtained by superimposing and displaying the crack of the past data and the crack of the detection result on the image captured using the image capturing parameter of EV0. The user can confirm a change in the detection result of the crack along with the change of the image capturing parameter by switching and displaying these images. In addition, the user may arbitrarily set display and non-display of the superimposed and displayed cracks. By setting non-display of the cracks, the user can confirm a portion of the captured image hidden by display of the cracks.

The plurality of image capturing parameters set for image capturing parameter adjustment are shown below the image 1001. In FIG. 10, three exposures (EV) are indicated by black triangles as examples of the plurality of image capturing parameters. Among these black triangles, a black triangle 1011 representing EV+1 indicating the highest evaluation value is highlighted (displayed in a large size). A white triangle 1012 and the like indicate a plurality of image capturing parameter candidates, set based on the image capturing parameter 1011 of EV+1, when further adjusting the image capturing parameter.

In this embodiment, the user confirms these pieces of information displayed on the display unit 1000 as the operation unit 105, and determines whether to adopt the current image capturing parameter or further perform the image capturing parameter adjustment processing. More specifically, the user compares the crack of the past data with that of the detection result in the image 1001 for which the highest evaluation value is obtained, and can determine, if the degree of matching is satisfactory, to adopt the image capturing parameter indicating the highest evaluation value. If the image capturing parameter indicating the highest evaluation value is adopted, the user presses an icon 1021 on which “set” is displayed. This operation sets the image capturing parameter indicating the highest evaluation value in the image capturing unit 101 (step S311 of FIG. 3), and ends the image capturing parameter adjustment processing.

On the other hand, if it is determined, by confirming the image 1001, that the current optimum image capturing parameter is unsatisfactory, the user presses an icon 1022 on which “readjustment” is displayed. This instruction re-executes the processes (target detection processing and evaluation value calculation processing) in step S306 and the subsequent steps of FIG. 3 using the plurality of next image capturing parameters (for example, the exposure indicated by the white triangle 1012 and the like). After that, various kinds of information are presented again to the user, as shown in the example of FIG. 10. Based on the presented information, the user determines again whether to adopt the image capturing parameter or further adjust the image capturing parameter.

If the image capturing parameter adjustment processing is stopped halfway, the user presses an icon 1023 on which “end” is displayed. This operation can end the image capturing parameter adjustment processing (the loop of the flowchart shown in FIG. 3). At this time, among the evaluated image capturing parameters used for image capturing, the image capturing parameter whose evaluation value is highest may be set in the image capturing unit 101.

By displaying the images captured using the plurality of image capturing parameters, the crack detection results obtained from the images, the past data, and the evaluation results of the respective image capturing parameters, the user readily sets the image capturing parameter suitable for inspection.

Note that in this case as well, the threshold sₜₕ of the evaluation value may be preset, and it may be displayed that there exists the image capturing parameter for which the evaluation value exceeding the threshold sₜₕ is obtained. For example, if, in FIG. 10, an evaluation value s1011 of an image captured using the image capturing parameter indicated by the black triangle 1011 exceeds the threshold sₜₕ, flickering display of the black triangle 1011 indicating the image capturing parameter may be performed. The user can adopt the image capturing parameter regardless of the evaluation value. However, by visually displaying the existence of the image capturing parameter exceeding the evaluation value, it is possible to assist determination of whether to adopt the image capturing parameter.

Furthermore, although not shown in FIG. 10, an image of the concrete wall surface when creating the past inspection result may be displayed in addition to the display contents of the display unit 1000 in FIG. 10. In this case, the image captured at the time of the past inspection is stored in the past data storage unit 106, and the image captured in the past is called simultaneously with calling of the past data (crack information) from the past data storage unit 106 in step S302 of FIG. 3.

### Modification

A modification of the first embodiment will be described below. If an image is captured by hand or by mounting the information processing apparatus on a drone in capturing an image a plurality of times in step S305 of FIG. 3, even if the same image capturing region is targeted and captured, the image capturing positions of the plurality of images may slightly shift from each other. The description of the first embodiment does not particularly mention the shift of the images. However, alignment between the past data and the images may be executed. This processing is executed immediately after capturing the plurality of images in step S305.

Alignment between the plurality of images is executed using a known method and a detailed description thereof will be omitted. Alignment can be executed by processing such as matching between feature points of the images or affine transformation (which may be limited to translation and rotation) of the images. Furthermore, to calculate an evaluation value, it is necessary to perform alignment with the crack of the past data. To do this, alignment is performed so that the detection result of the crack detected from each image in step S306 is most similar to the position and shape of the crack of the past data. Alignment in this processing may be performed by transforming the captured images or by transforming the image of the crack detection result.

The first embodiment has explained the example of estimating a method of improving the image capturing parameter. However, the image capturing method suitable for capturing a crack to be estimated is not limited to the image capturing parameter, and another image capturing method may be estimated. In an embodiment of estimating an image capturing method other than the image capturing parameter, if an evaluation value equal to or higher than the predetermined threshold is not obtained even by executing the loop of the processing procedure shown in FIG. 3 a plurality of times, the images and the image capturing status are further analyzed to recommend an appropriate image capturing method.

If, for example, it is determined that the brightness of the image is insufficient or it is determined that the white balance cannot be adjusted by the image capturing parameter, a notification may be made to the user to use illumination or capture an image at a time when it is light by changing the image capturing time. As another example, if the position and orientation of the image capturing unit 101 can be acquired, the positional relationship with the inspection target structure is analyzed to propose the position and orientation for improving image capturing. More specifically, for example, if an image is captured at the position and orientation at which the tilt angle with respect to the wall surface of the inspection target structure is large, it is recommended to the user to capture an image at the position and orientation at which the tilt angle is decreased.

The first embodiment has exemplified the crack as an inspection target. However, the inspection target is not limited to the crack, and may be another variation. In this case, as the inspection target to be used for image capturing parameter adjustment, a variation with a less change in appearance caused by aging from the past inspection result is preferably used. For example, a cold joint as a discontinuous surface at the time of placing concrete or the like does not largely change in appearance of a portion recorded in the past, similar to the crack, and is thus a preferable example of the target. A concrete joint or placing joint can be set as an inspection target although it is not a variation. In this case, the image capturing parameter may be adjusted by comparing the position and shape of the concrete joint or placing joint observed at the time of past inspection with those of the joint or placing joint detected from a currently captured image.

As described above, according to this embodiment, an inspection target structure whose past inspection result is recorded is captured using a plurality of image capturing parameters to create a plurality of images. Inspection target detection processing is executed for each of the plurality of images. The evaluation value of each image capturing parameter is calculated from the detection result of each image and the past inspection result. Then, if the highest evaluation value is equal to or higher than the threshold, the image capturing parameter indicating the highest evaluation value is set as an image capturing parameter to be used. On the other hand, if the highest evaluation value is equal to or lower than the threshold, an image capturing parameter for improving the evaluation value is estimated.

According to this embodiment, it is possible to estimate an image capturing method (for example, an image capturing parameter) suitable for comparison with the past result without confirming the captured image by the user.

### Second Embodiment

In the first embodiment, the image capturing parameter is adjusted by comparing the crack detection result of the captured image with the past data (past crack inspection result). In addition, the image capturing parameter may be adjusted by further comparing an image (to be referred to as a current image hereinafter) currently captured for image capturing parameter adjustment with an image (to be referred to as a past image hereinafter) captured in the past.

The second embodiment will describe an example of adjusting an image capturing parameter by comparing a current image with a past image.

To perform comparison with a past inspection result, it is necessary to capture an image in which a crack recorded in the past inspection result can be observed even as an image captured in current inspection. To do this, in the first embodiment, the image capturing parameter is adjusted using the past data and the detection result. If there exists an image captured in past inspection, it is desirable to confirm aging such as extension of a variation by visually comparing the current image with the past image. At this time, to compare the current image with the past image, the current image is preferably an image in which a crack recorded in the past inspection result can be observed and which is also similar in appearance such as the brightness or white balance to the past image.

Therefore, in the second embodiment, similarity between the past image and the current image is calculated, and an evaluation value is calculated in consideration of the similarity, thereby adjusting the image capturing parameter. This makes it possible to set the image capturing parameter for capturing an image so that the current image is similar in appearance to the past image. The difference from the first embodiment will mainly be described below. The remaining components and processes are similar to those in the first embodiment and a description thereof will be omitted.

A past data storage unit 106 stores not only a past inspection result but also an image obtained by capturing an inspection target structure in the past. If an arbitrary image capturing range of the inspection target structure is set in step S301 of FIG. 3, a past image concerning the image capturing range is called together with past data in step S302. After images are captured using a plurality of parameters in step S305, and crack detection is executed for each current image in step S306, an evaluation value is calculated in step S307. In the second embodiment, an evaluation value s′ is calculated, as follows, based on one image (current image) captured using a given image capturing parameter, the past image, and the past data.

$${s}^{′} = \frac{α}{p ( C )} {\sum }_{i ∈ C} {f}_{i} + β r ( {I}_{o} , {I}_{n} ) \qquad ( 4 )$$

where the first term represents an evaluation value based on the crack, given by equation (2) in the first embodiment, and r(Io, In) of the second term represents similarity between a past image Io and a current image In. The similarity between the images may be obtained by any method but represents, for example, a value indicating the similarity of a luminance distribution or color distribution. Alternatively, a distance in some image feature amount space or the like may be set as the similarity. However, similarity suitable to the human sensitivity should be calculated rather than the similarity of the geometric characteristic between the images, such as the brightness, tone, or white balance. Note that in equation (4), α and β represent weighting factors for the first term (the evaluation value of the crack) and the second term (the similarity between the past image and the current image), and are parameters for deciding which of the terms is weighted to calculate the evaluation value s′, where α≥0 and β≥0.

By executing the processing of the first embodiment using the evaluation value s′ calculated, as described above, it is possible to adjust the image capturing parameter so that the past image and the current image are similar to each other.

### Third Embodiment

The first embodiment has explained the example of adjusting the image capturing parameter using the past data of the given image capturing range 220 of the pier 201 shown in FIG. 2, and capturing the pier 201 using the image capturing parameter. In capturing the pier 201, a plurality of images are captured by repeatedly, partially capturing the pier 201, and connected, thereby creating a high-resolution concrete wall surface image. However, as for the same pier 201, it is preferable to capture the pier 201 using an appropriate image capturing parameter depending on the portion.

The third embodiment will describe an example of adjusting an image capturing parameter for each of a plurality of portions (a plurality of image capturing ranges) on one given wide wall surface of an inspection target structure.

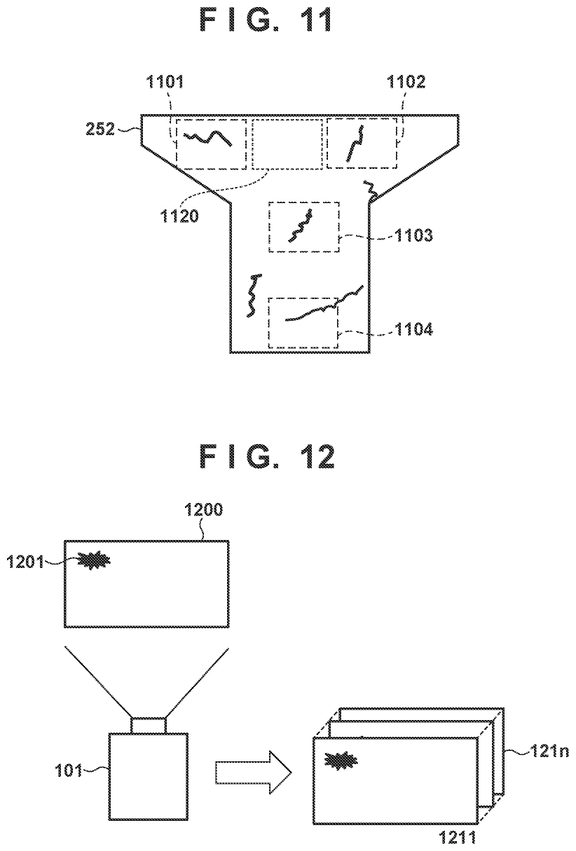

FIG. 11 shows a drawing 252 of a pier 251 (a pier different from the pier 201 used in the description of the first embodiment) shown in FIG. 2. Each of image capturing ranges 1101, 1102, 1103, and 1104 is an image capturing range including a crack. For each of the image capturing ranges, an image capturing parameter suitable for capturing each image capturing range is set using the method according to the first embodiment. Similar to the first embodiment, each of the image capturing ranges 1101, 1102, 1103, and 1104 is decided when the user selects it or when an information processing apparatus 100 recommends a region whose past data includes a crack.

Then, in the third embodiment, selection is made from positions distributed coarsely as much as possible or distributed uniformly within the range (in this embodiment, the range of the drawing 252 shown in FIG. 11) of a given wall surface. As shown in FIG. 11, these image capturing ranges are not adjacent to each other and set at positions distributed over the entire region of the drawing 252. The information processing apparatus 100 recommends image capturing ranges to the user so that the plurality of image capturing ranges are set in this way.

Note that in the example shown in FIG. 11, an example of setting the four image capturing ranges is described. However, the number of image capturing ranges set on a given wall surface is not limited to this. If the number of image capturing ranges is large, an image capturing parameter suitable to each portion of the wall surface can be set but it takes time to adjust the image capturing parameter. Since these have a tradeoff relationship, the number of image capturing ranges to be set is set in accordance with a request.

Next, the image capturing parameter suitable for capturing each image capturing range is decided using past data of each image capturing range by the method described in the first embodiment. An image capturing parameter for a portion other than these image capturing ranges is obtained by interpolation or extrapolation based on the image capturing parameter set for each image capturing range. For example, as an image capturing parameter for capturing a range 1120 is set as an image capturing parameter obtained by linear interpolation based on the image capturing parameters for the peripheral image capturing ranges (for example, the image capturing parameters for the image capturing ranges 1101 and 1102). This can set an image capturing parameter for each portion of the wall surface.

Furthermore, in the third embodiment, the image capturing parameter may be adjusted by setting a constraint condition so the image capturing parameter does not largely change for the same image capturing target. For example, if the image capturing parameter largely changes depending on a portion of the pier 251 when capturing the pier 251 shown in FIG. 2 corresponding to the drawing 252 shown in FIG. 11, a high-resolution image obtained by connecting the captured images has no uniformity. Therefore, in capturing a group of continuous portions like the pier 251, images are preferably captured using image capturing parameters similar to each other as much as possible. To do this, as the difference from the image capturing parameter decided for an image capturing region adjacent to that currently captured or another image capturing region included in the wall surface currently captured is larger, a larger penalty is given to the evaluation value for adjusting the image capturing parameter. This makes it possible to suppress a large change in image capturing parameter in capturing a group of continuous portions like the pier 251.

According to this embodiment, it is possible to estimate an image capturing method suitable for comparison with a past result for each image capturing range.

### Fourth Embodiment

Each of the above-described embodiments has explained the method of estimating an image capturing parameter improving method using a plurality of evaluation values when the evaluation value is lower than the predetermined threshold (For example, FIG. 9B). However, the method of estimating an image capturing parameter improving method is not limited to processing using a plurality of evaluation values, and a method of estimating an image capturing parameter improving method based on one given evaluation value and an image capturing parameter concerning the evaluation value may be used. In the fourth embodiment, with respect to this method, the difference from the first embodiment will be described with reference to the flowchart shown in FIG. 3.

In the fourth embodiment, since a plurality of evaluation values are not calculated, it is unnecessary to capture images using a plurality of image capturing parameters. Therefore, in the flowchart shown in FIG. 3 according to the first embodiment, step S304 in which a plurality of image capturing parameters are set and step S305 in which an image is captured a plurality of times are not executed.

In the fourth embodiment, one image of an image capturing range is captured using a given initial parameter. For this one image, processing S306 of detecting a target (crack) and processing S307 of calculating an evaluation value by comparing a detection result with past data are executed. These processes are the same as in the first embodiment. If the calculated evaluation value is equal to or higher than the threshold, parameter setting end processing (steps S308, S309, and S311 of FIG. 3) is also executed, similar to the first embodiment.

Processing different from the first embodiment is processing in step S310 in which an image capturing parameter improving method is estimated when the evaluation value is equal to or lower than the threshold. In the fourth embodiment, an improved image capturing parameter is estimated by a statistical technique from one given evaluation value and an image capturing parameter at this time. Therefore, in the fourth embodiment, the relationship between the evaluation value and the improved image capturing parameter is learned in advance. This relationship can be learned using, for example, the following data.

X=[(s₁,p₁),(s₂,p₂), . . . ,(sₙ,pₙ)]^{T} (5)

Y=[p_{dst_1},p_{dst_2}, . . . ,p_{dst_n}]^{T} (6)

In equation (5), pₙ represents an image capturing parameter and sₙ represents an evaluation value obtained from an image captured using pₙ. Assume that sₙ is an evaluation value equal to or lower than the threshold. In equation (6), p_{dst_n} represents an image capturing parameter when the image capturing parameter is adjusted from a state of (sₙ, pₙ) and the evaluation value finally becomes equal to or higher than the threshold. Learning data (X, Y) is created by collecting n sets of data. When an evaluation value s lower than the threshold and an image capturing parameter p are input, a model M that outputs an improved parameter pas is learned using the learning data.

p_{dst}=M(s,p) (7)

Any algorithm can be used to learn this model. If, for example, the image capturing parameter is a continuous value, a regression model of linear recurrence or the like can be applied.

When the model M prepared in advance as described above is used for the improved image capturing parameter estimation processing in step S310, it is possible to estimate the improved image capturing parameter from one image in the fourth embodiment.

Note that as a method of obtaining the improved image capturing parameter, the arrangement using the learned model may be used in the method of capturing images using a plurality of image capturing parameters according to the first embodiment. That is, the model M is not limited to the arrangement of estimating the image capturing parameter from one image, and may be used in the method of estimating an image capturing parameter from a plurality of images. In this case, the model M is learned, which calculates evaluation values respectively from a plurality of images captured using a plurality of image capturing parameters, similar to the first embodiment, and obtains an improved image capturing parameter by inputting the plurality of image capturing parameters and the plurality of evaluation values. Learning data X for learning this model M is rewritten from equation (5) to equation (8) below when the number of images captured in image capturing parameter adjustment is represented by m. Note that an objective variable (or supervised data) Y is the same as that given by equation (6).

X=[(s₁₁,p₁₁,s₁₂,p₁₂, . . . ,s₁ₘ,p₁ₘ), . . . ,(sₙ₁,pₙ₁,sₙ₂,pₙ₂, . . . ,sₙₘ,pₙₘ),]^{T} (8)

According to this embodiment, it is possible to estimate an improved image capturing parameter from one image.

### Fifth Embodiment

In each of the above-described embodiments, inspection of a structure having a concrete wall surface has been exemplified. However, an application of the present invention is not limited to this, and the present invention may be used for other purposes. The fifth embodiment will exemplify, an apparatus (appearance test apparatus) that captures an image of a product in a factory or the like and detects a defect such as a flaw.

FIG. 12 is a view for explaining an appearance test. An object 1200 is a target of an appearance test of a part, a product, or the like. In the appearance test, the object 1200 is captured by an image capturing unit 101 to detect a defect 1201 of the object 1200. To detect a defect from the captured image, it is necessary to adjust, in advance, a predetermined image processing parameter for enhancing the defect. In an appearance test using mechanical learning, it is necessary to learn a model for identifying an image feature of a defect from an image of a normal object or an image of an object including the defect.

A case in which the image capturing unit 101 (the image capturing unit 101 may include an illumination device) is replaced is now considered. If the specification of the new image capturing unit 101 is different from that of an old image capturing unit 101, even if the same image capturing parameter is set, there is a small difference between captured images. Since the image processing parameter and the defect identification model are decided based on an image captured by the old image capturing unit 101, readjustment or relearning is required. For readjustment or relearning, it is necessary to capture a number of images of the object 1200 by the new image capturing unit 101. Thus, it takes time to resume the operation of a production line using the appearance test apparatus.

Therefore, the image capturing parameter adjustment method of the present invention is applied, and the image capturing parameter with which an image similar to that captured by the past image capturing unit 101 can be captured is set in the new image capturing unit 101. To do this, an object including a defect is prepared. This will be referred to as a reference object hereinafter. Assume that the reference object is inspected by the old image capturing unit 101 in the past, and a detection result of the defect is stored in a past data storage unit 106. Then, the reference object is captured by the new image capturing unit 101 using a plurality of different image capturing parameters.

FIG. 12 shows images 1211 to 121n captured by the new image capturing unit 101 using n image capturing parameters when the object 1200 is set as the reference object. Defect detection processing is performed for the n images, the detection results are compared with a detection result obtained by the old image capturing unit 101 and stored in the past data storage unit 106, and then an evaluation value concerning each image capturing parameter is calculated. Then, the image capturing parameter of the new image capturing unit 101 is adjusted based on these evaluation values. The processing contents of the above processing are the same as in the first embodiment except for the image capturing target, and a detailed description thereof will be omitted.

This can readily set, in the new image capturing unit, the image capturing parameter with which a defect detected by the old image capturing unit can be detected.

Note that the example of applying the present invention when replacing the image capturing unit of the appearance test apparatus has been explained above but the method of applying the present invention to the appearance test apparatus is not limited to this. For example, consider a case in which the appearance text apparatus is newly introduced to a plurality of production lines for producing the same product in a factory. If the production line is different, for example, the influence of external light is different, and it is thus necessary to adjust an optimum image capturing parameter in each production line.

In this case, the parameter of the image capturing unit of the appearance test apparatus in the first production line is manually adjusted. Then, the appearance test apparatus in the first production line captures an image of an object to perform defect identification model learning or image processing parameter adjustment of defect detection. At least one object including a defect is set as a reference object, and the appearance test apparatus in the first production line executes defect detection of the reference object. This detection result is stored as past data in the past data storage unit 106.

In the second production line different from the first production line, the image processing parameter and the defect identification model set in the first production line are used. Then, the image capturing parameter of the image capturing unit in the second production line is adjusted by the method of the present invention so as to obtain the same detection result as that in the first production line. In this image capturing parameter adjustment processing, the image capturing unit in the second production line captures the reference object, and an obtained detection result is compared with the detection result, stored in the past data storage unit 106, of the reference object in the first production line, thereby calculating the evaluation value of the image capturing parameter. The image capturing parameter in the second production line is adjusted based on the evaluation value.

According to this embodiment, when replacing the image capturing unit in the appearance test apparatus, it is possible to readily set, in the new image capturing unit, the image capturing parameter with which a defect detected by the old image capturing unit can be detected.

### Sixth Embodiment

The sixth embodiment will exemplify image capturing parameter adjustment in image capturing for image inspection of an infrastructure. The infrastructure is, for example, a bridge, a dam, a tunnel, or the like. In image inspection, an image for inspection is created by capturing the concrete wall surface of the structure. Therefore, in this embodiment, the concrete wall surface is an image capturing target. The target of image inspection may be an image obtained by setting, as an image capturing target, another structure or the surface of a material other than concrete. For example, if the inspection target is a road, an asphalt surface may be set as the image capturing target.

In this embodiment, a reference image as an image of ideal image quality is prepared, and an image capturing method is adjusted so that an image obtained by capturing an image capturing target is similar to the reference image. The reference image is an image, among concrete wall surface images captured in the past, in which an inspection target such as a fine crack difficult to capture can clearly be confirmed. That is, the reference image is an image captured with quality such that a focus, brightness, tone, and the like are preferable as an inspection image. The main image capturing method adjusted in this embodiment is the image capturing parameter of an image capturing unit, and is, for example, an exposure, a focus, a white balance (color temperature), a shutter speed, or a stop. A method of adjusting the image capturing method using the reference image will be described below.

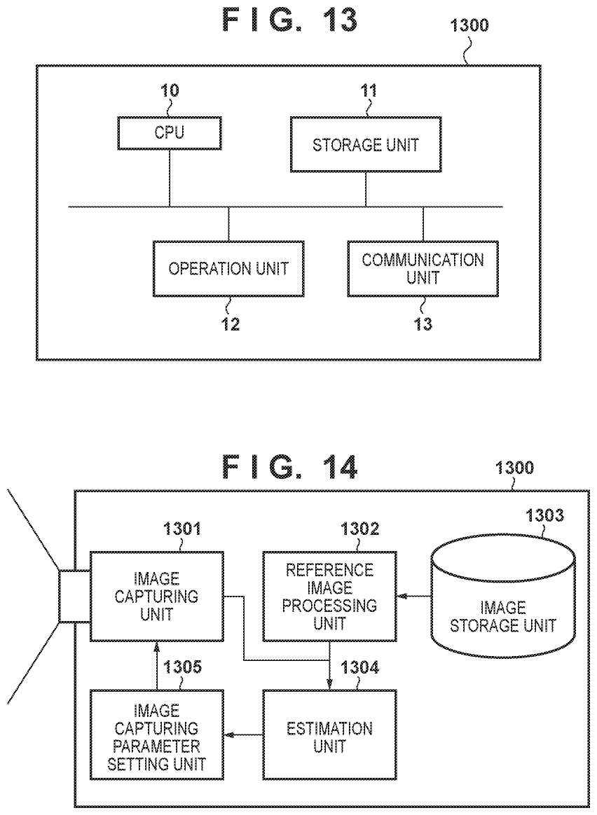

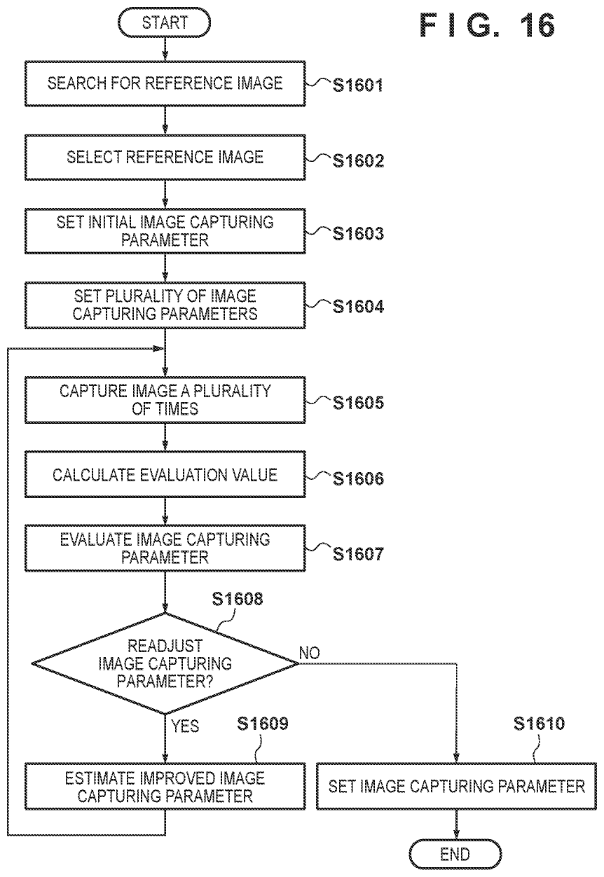

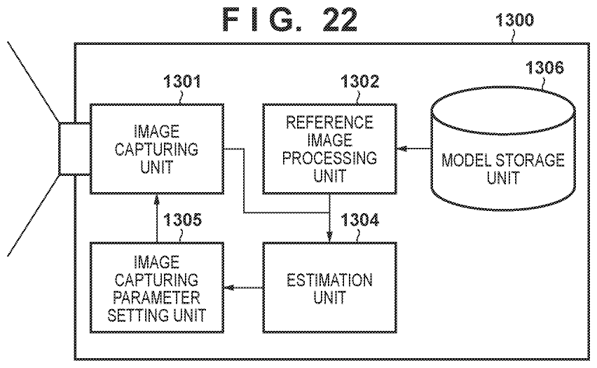

FIG. 13 is a view showing an example of the hardware arrangement of an information processing apparatus 1300. The information processing apparatus 1300 may be integrated with an image capturing unit 1301 shown in FIG. 14 (to be described later) and included in the housing of a camera, or may be configured to transmit, wirelessly or via a wire, an image captured by the image capturing unit 1301 and formed by a housing (for example, a computer or a tablet) different from the camera including the image capturing unit 1301. In the example shown in FIG. 13, the information processing apparatus 1300 includes, as a hardware arrangement, a CPU 10, a storage unit 11, an operation unit 12, and a communication unit 13. The CPU 10 controls the overall information processing apparatus 1300. When the CPU 10 executes processing based on a program stored in the storage unit 11, components denoted by reference numerals 1302, 1304, and 1305 of FIGS. 14 and 22 (to be described later) and processing of a flowchart shown in FIG. 16 (to be described later) are implemented. The storage unit 11 stores a program, data and an image to be used by the CPU 10 to execute the processing based on the program, and the like. The operation unit 12 displays the result of the processing of the CPU 10, and inputs a user operation to the CPU 10. The operation unit 12 can be formed by the display and touch panel on the rear surface of the camera or the display and interface of a notebook PC. The communication unit 13 connects the information processing apparatus 1300 to the network, and controls communication with another apparatus and the like.

FIG. 14 is a block diagram showing an example of the arrangement of the information processing apparatus 13M) according to the sixth embodiment. The information processing apparatus 1300 includes, as components, the image capturing unit 1301, the reference image processing unit 1302, an image storage unit 1303, the estimation unit 1304, and the image capturing parameter setting unit 1305. However, as described above, the image capturing unit may or may not be included in the information processing apparatus 1300. The reference image processing unit 1302, the estimation unit 1304, and the image capturing parameter setting unit 1305 are software components. The image storage unit 1303 may be provided in the storage unit 11, or may be provided in a storage server communicable with the information processing apparatus 1300. If the image storage unit 1303 is provided in the storage server, the reference image processing unit 1302 acquires, via the network, an image saved in the image storage unit 1303 and information associated with the image. The image storage unit 1303 is a storage that stores a group of images as candidates of the reference image.

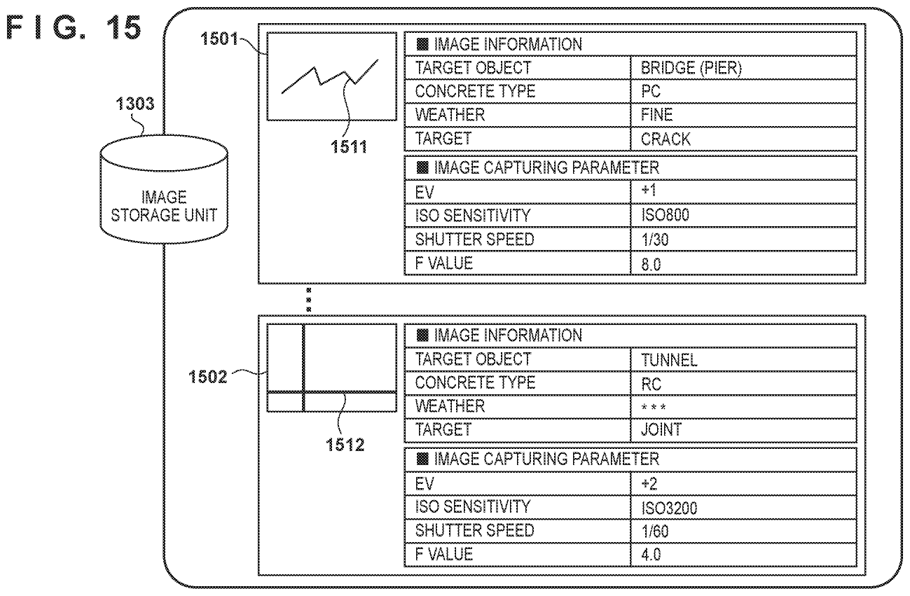

FIG. 15 is a view for explaining information stored in the image storage unit 1303. The image storage unit 1303 stores a plurality of images (in FIG. 15, images 1501 and 1502). The images 1501 and 1502 stored in the image storage unit 1303 will be referred to as stored images hereinafter. The stored images are images prepared by collecting images captured with preferable quality for image inspection from images obtained by capturing the concrete wall surfaces of various structures. The preferable quality for image inspection indicates quality with which a variation such as a crack is readily confirmed when a human confirms the image, and for example, a focus, brightness, tone, and the like are preferable. For example, the stored image 1501 is an image in which a crack 1511 can clearly be confirmed. The stored image is not limited to an image including a crack. The stored image 1502 is an image including joints 1512 of the concrete wall surface. The stored image 1502 is determined as an image with preferable quality for inspection since it clearly includes the edges of the joints 1512.

Furthermore, if the captured image is inspected using a technique of automatically detecting a crack from the captured image, quality with which automatic detection processing operates preferably may be set as preferable quality for image inspection. In this case, the correct answer rate of the detection result of the automatic detection processing or the like is calculated, and the image of quality with which the correct answer rate or the like is high is set as a stored image.

In the image storage unit 1303 shown in FIG. 15, image information and an image capturing parameter are associated with the stored image and recorded. The image information is information about image capturing contents of the stored image, and includes, for example, the structure type of a target object, a concrete type, the weather at the time of image capturing, a target in the image, the installation location/region of the structure, and the number of elapsed years. The image capturing parameter is an image capturing parameter used to capture each reference image.

FIG. 16 is a flowchart illustrating an example of information processing. The operation of the information processing apparatus 1300 will be described below with reference to the flowchart.

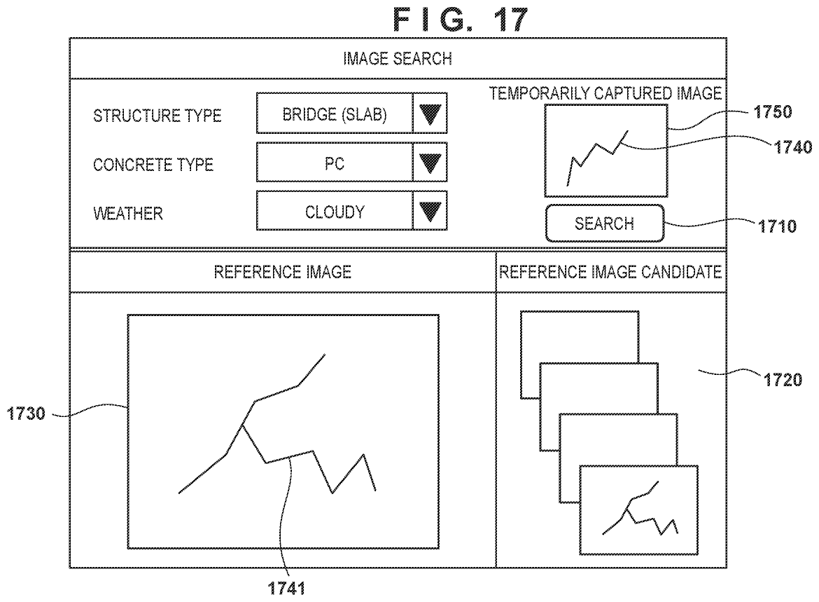

Steps S1601 and S1602 correspond to processing executed by the reference image processing unit 1302. The reference image processing unit 1302 of the sixth embodiment executes processing of selecting a reference image from the images stored in the image storage unit 1303. FIG. 17 shows information displayed on the operation unit 12 at the time of executing steps S160 and S1602.

In step S1601, the reference image processing unit 1302 searches for a reference image candidate from the image storage unit 1303 based on a search condition. As a method of searching for a reference image candidate, there is provided a method using image information. As shown in FIG. 15, the image stored in the image storage unit 1303 is associated with the image information. The reference image processing unit 1302 can search for a stored image similar to the image capturing target based on the information. FIG. 17 shows an example of a screen for searching for the stored image in the operation unit 12. For example, assume that the image capturing target is a slab of the bridge and the weather at the time of image capturing is cloudy. The user sets, as the image search condition, a condition concerning an image capturing status or the image capturing target. Then, by selecting a search button 1710, the stored image corresponding to the search condition can be found from the image storage unit 1303. The search result is displayed as a reference image candidate in a reference image candidate display field 1720. Only the stored image whose image information matches the search condition may be set as the reference image candidate, or a predetermined number of stored images each having high degree of matching of an item may be selected and set as reference image candidates. In the example shown in FIG. 17, as the image information for a search, only the structure type, the concrete type, and the weather are displayed, but the condition for the image search is not limited to them. Furthermore, FIG. 17 shows, as a search method, the method of setting search contents by pull-down menus but a method of inputting, by the user, image information for a search is not limited to this. For example, an operation method capable of searching for the stored image by inputting a free character string as a keyword may be used.

As another method of searching for the reference image candidate, there is provided a method using a temporarily captured image. In this case, the user captures the image capturing target by the image capturing unit 1301. This image capturing operation is a temporary image capturing operation, and the image capturing parameter at this time is set using automatic setting. The image captured by the temporary image capturing operation is a temporarily captured image. The user sets the temporarily captured image as a search key of reference image candidate selection. FIG. 17 shows a state in which a temporarily captured image 1750 is set as the search condition of reference image candidate selection. In this state, when the search button 1710 is selected, an image similar to the temporarily captured image is searched for from the image storage unit 1303. As a result of the search, a stored image having high similarity is selected as a reference image candidate, and displayed in the reference image candidate display field 1720. In the search using the temporarily captured image, for example, the similarity with the stored image is calculated based on the feature (the tone or texture of the concrete wall surface) of the entire image, and a reference image candidate is selected. This can search for the stored image in which the concrete wall surface of the image capturing target to be captured for inspection is similar. Alternatively, the reference image candidate may be searched for by using a search by the above-described image information (keyword) and a search by the temporarily captured image at the same time.

A reference image candidate is selected and displayed in the reference image candidate display field 1720, as described above.

In step S1602 of FIG. 16, the reference image processing unit 1302 selects, as a reference image, one of the reference image candidates displayed in the reference image candidate display field 1720. First, as an initial value of reference image selection, the reference image candidate having the highest degree of matching of the search is automatically selected as a reference image. FIG. 17 shows a state in which a thus selected reference image 1730 is displayed in a reference image display field. The user can confirm a reference for adjusting the image capturing method by confirming the thus displayed reference image. If the user determines that the selected reference image 1730 is inappropriate as an adjustment reference, he/she can select, as a reference image, another image from the reference image candidates. If another image is selected from the reference image candidates, the reference image processing unit 1302 sets the selected image as a reference image.

Note that the image shown in FIG. 17 includes a crack (for example, 1740 or 1741). As will be described later, if an evaluation value is calculated using an image of a crack portion, the reference image needs to include the crack. By setting, as the temporarily captured image 1750, the image including the crack 1740, it may be possible to search for the stored image including a crack similar to the crack of the image capturing target in the search for the reference image candidate.

In step S1603, the image capturing parameter setting unit 1305 decides the initial value (to be referred to as an initial image capturing parameter hereinafter) of the image capturing parameter. The initial image capturing parameter is set by setting, as an initial parameter, an image capturing parameter decided by the normal image capturing parameter adjustment method (automatic parameter adjustment) of the image capturing apparatus. As another method, an image capturing parameter associated with the reference image may be set as an initial parameter. As shown in FIG. 15, the image storage unit 1303 records, for each stored image, an image capturing parameter at the time of capturing the image. Therefore, if the image capturing parameter associated with the reference image is set as an initial parameter, the reference image processing unit 1302 calls, from the image storage unit 1303, the image capturing parameter associated with the image selected as the reference image, and sets it as the initial parameter.

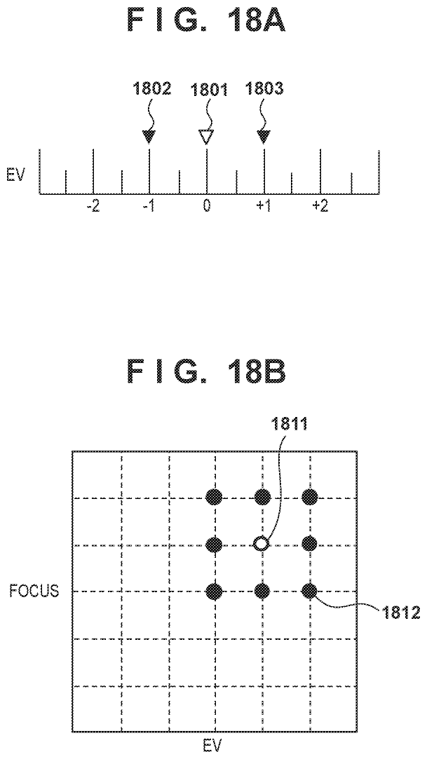

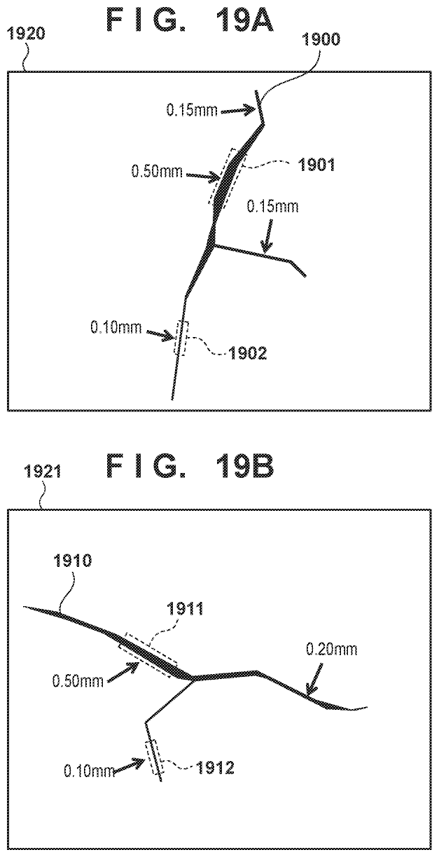

In step S1604, the image capturing parameter setting unit 1305 sets a plurality of image capturing parameters based on the initial image capturing parameter. FIGS. 18A and 18B each show a state in which a plurality of image capturing parameters are set based on the initial image capturing parameter. FIG. 18A is a view for explaining an embodiment of adjusting an exposure (EV) as an example of the image capturing parameter adjusted by the method of this embodiment. In FIG. 18A, a state in which EV0 is set as the initial parameter is indicated by a white triangle 1801. The image capturing parameter setting unit 1305 sets a plurality of image capturing parameters by centering the initial parameter. In FIG. 18A, the image capturing parameter setting unit 1305 changes the exposure by one step by centering EV0, thereby setting, as a plurality of parameters, EV−1 (a black triangle 1802 of FIG. 18A) and EV+1 (a black triangle 1803 of FIG. 18A). This example shows a state in which the three image capturing parameters including the initial image capturing parameter are set. However, the number of set image capturing parameters is not limited to this. For example, the image capturing parameter setting unit 1305 may set exposures different by two steps, thereby setting the five image capturing parameters in total.

In this example, a plurality of image capturing parameters are in accordance with the rule of changing the exposure by one step. However, the change step of the image capturing parameter may be set by other setting methods. For example, the image capturing parameter setting unit 1305 may set the exposure by a step of ½, or randomly set around the initial image capturing parameter.

The embodiment has been described above with respect to a case in which the exposure is used as the image capturing parameter. However, the image capturing parameter set in this embodiment is not limited to the exposure. Any parameter for controlling the image capturing unit 1301 may be used as an image capturing parameter, and examples of the image capturing parameter are a focus, a white balance (color temperature), a shutter speed, a stop, an ISO sensitivity, and the saturation and tone of an image.

The embodiment in which only the exposure is set as the image capturing parameter to be adjusted in this embodiment has been explained with reference to FIG. 18A. However, a plurality of image capturing parameters may be adjusted simultaneously. For example, FIG. 18B is a view for explaining an embodiment in which a combination of the exposure and focus is set as an image capturing parameter to be adjusted. In FIG. 18B, a combination of given exposure and focus is set as an initial parameter, which is indicated by a white circle 1811. The image capturing parameter setting unit 1305 may set, as a plurality of image capturing parameters, for example, combinations of image capturing parameters indicated by black circles 1812 by centering the initial parameter.

Note that the combination of image capturing parameters as an adjustment target is not limited to the combination of the exposure and focus shown in FIG. 18B, and may be a combination of other image capturing parameters. Furthermore, the embodiment of adjusting the combination of two parameters has been explained above. However, the number of image capturing parameters is not limited to this, and a combination of three or more image capturing parameters may be adjusted simultaneously.

In step S1604, as described above, the image capturing parameter setting unit 1305 sets a plurality of image capturing parameters. In the following description of the processing, a case in which the exposure is set as the image capturing parameter to be adjusted, as shown in FIG. 18A, will be described.

In step S1605 of FIG. 16, the image capturing unit 1301 captures the image capturing target using the plurality of image capturing parameters set in step S1604. More specifically, if three exposures are set as a plurality of image capturing parameters, as shown in FIG. 18A, the image capturing unit 1301 automatically captures three images while changing the exposure in accordance with a shutter operation of the user. The images captured in this step will be referred to as captured images hereinafter.

Processing in step S1606 and subsequent steps of FIG. 16 is processing mainly executed by the estimation unit 1304, and is processing of selecting an optimum image capturing parameter or processing of further searching for an optimum image capturing parameter.

In step S1606, the estimation unit 1304 calculates an evaluation value for each of the plurality of image capturing parameters. The evaluation value has a higher value as the image capturing parameter is more appropriate for capturing an inspection image. The estimation unit 1304 calculates the evaluation value by comparing the image captured using each image capturing parameter with the reference image. More specifically, if the captured image is similar to the reference image, it can be determined that the image capturing parameter with which the image is captured is a preferable parameter. Therefore, in this case, the estimation unit 1304 calculates a high evaluation value. To calculate the evaluation value, the similarity between the captured image and the reference image is calculated. A practical example of the evaluation value calculation method will be described below.

As an example of the method of calculating the evaluation value between the captured image and the reference image, a method of calculating the similarity between the entire images and using it as an evaluation value will be described first. For example, if the similarly between the entire images is obtained by comparing between the brightnesses of the entire images, the captured image and the reference image are grayscale-transformed to create luminance histograms of the entire images, and then the similarity between the luminance histogram of the captured image and that of the reference image is calculated. The similarity between the histograms can be calculated by a method of simply calculating the Euclidean distance or a histogram intersection method or the like. If the similarity between the tones of the entire images is calculated, a color histogram of each image is created based on a color space such as a RGB or YCrCb color space without performing grayscale transformation, and the similarity between the color histograms is calculated. Feature amounts for determining the similarity between the entire images are not limited to histogram feature amounts and other feature amounts may be used.

As another example of the evaluation value calculation method, the partial similarity between images may be calculated. For example, if the user wants to capture an inspection image of the concrete wall surface, a portion of interest is a portion including the concrete wall surface in an image. Therefore, if the captured image and the reference image each include a portion other than the concrete wall surface, similarity may be calculated based on images of portions of the concrete wall surface, each obtained by excluding the portion other than the concrete wall surface. More specifically, for example, when capturing the slab of the bridge from the lower side of the bride, a captured image may include a sky region (background portion). The estimation unit 1304 removes the sky region from such captured image, and calculates an evaluation value by calculating the similarity between the reference image and the image portion of the concrete wall surface of the slab. In calculation of the similarity, the above-described histogram feature amount is created for each of the entire reference image and the partial image of the captured image, and the similarity between the histogram feature amounts is calculated. This example is an example of calculating the similarity between the reference image and the partial image of the captured image by assuming that the entire reference image is a concrete wall surface image. However, if the reference image partially includes a portion considered as a background, the similarity between the partial image of the reference image and the captured image may be calculated.

Another method of calculating the partial similarity between images will be described. In capturing a concrete wall surface image for image inspection, it is important to capture an image with quality such that a fine crack can be confirmed in the captured image. Assuming that the reference image is an ideal inspection image in which a fine crack can sufficiently be confirmed, a fine crack portion of the captured image is preferably captured, similar to the fine crack portion of the reference image. To determine whether the crack portion is similarly captured, the estimation unit 1304 calculates an evaluation value using the partial image of the crack portion in the image. Any method may be used as the evaluation value calculation method for the image of the crack portion. In the following example, however, a higher evaluation value is calculated as the similarity in edge intensity of the crack portion is higher. To do this, the estimation unit 1304 specifies the crack portion of each of the captured image and the reference image. The crack portion specifying method may be automatically executed or manually executed by the user. If a crack is detected automatically, the estimation unit 1304 is assumed to use processing of automatically detecting a crack. If a crack position is manually specified, the estimation unit 1304 receives an input of a crack position in the image by the user via the operation unit 12. With respect to the captured image, it is necessary to specify a crack position by these processes after image capturing. However, the crack position in the reference image may be specified in advance, and recorded in the image storage unit 1303 in association with the stored image. If the crack position in each of the captured image and the reference image is obtained, as described above, the estimation unit 1304 calculates the edge intensity of the image at each crack position. The luminance value at the crack position may simply be used as the edge intensity, or the gradient at the crack position may be calculated by a Sobel filter or the like and the gradient intensity may be used as the edge intensity. Since the edge intensity is obtained on a pixel basis, it is necessary to create the edge intensity feature amounts of the entire images in order to calculate the similarity between the edge intensity of the captured image and that of the reference image. To do this, for example, the estimation unit 1304 creates a histogram feature amount by generating a histogram of the edge intensity at the crack position in each image. The estimation unit 1304 calculates the similarity between the edge intensity histogram feature amount of the captured image and that of the reference image, and obtains a higher evaluation value between the captured image and the reference image as the similarity is higher.

Note that to calculate an evaluation value based on the edge intensities of crack portions, as described above, it is assumed that each of the captured image and the reference image includes a crack. With respect to the captured image, when the user captures a portion including a crack from the concrete wall surface of the image capturing target, it is possible to acquire the captured image including the crack. On the other hand, with respect to the reference image, in steps of selecting the reference image in steps S1601 and S1602, the user performs a search, selection, and the like so that an image including a crack is selected as the reference image from the images stored in the image storage unit 1303.

In the above example, the evaluation value between the captured image and the reference image is calculated based on the edge intensities at the crack positions, but a crack does not always exist on the concrete wall surface of the image capturing target. Therefore, the estimation unit 1304 may calculate an evaluation value based on the edge intensity of the image edge portion such as a concrete joint or shuttering mark that surely appears based on the concrete structure. In this case, it is possible to calculate an evaluation value by the same method as the above-described evaluation value calculation method using the edges of the crack portions except that the edge intensity of the portion of the concrete joint or shuttering mark included in each of the captured image and the reference image is used.

Note that to calculate an evaluation value based on the edge intensity of the concrete joint, as described above, it is assumed that each of the captured image and the reference image includes the concrete joint. With respect to the captured image, when the user captures a portion including the concrete joint from the concrete wall surface of the image capturing surface, it is possible to acquire the captured image including the crack. On the other hand, with respect to the reference image, in steps of selecting the reference image in steps S1601 and S1602, the user performs a search, selection, and the like so that an image including the concrete joint is selected as the reference image from the images stored in the image storage unit 1303.

As a modification of calculation of an evaluation value using the edge intensity at the crack position, the estimation unit 1304 may calculate the evaluation value between the edge intensity of the captured image and that of the reference image using crack width information. In this method, the estimation unit 1304 calculates a higher evaluation value as the similarity between the edge intensities of the cracks of the same width in the captured image and the reference image is higher. FIGS. 19A and 19B are views each for explaining the evaluation value calculation method based on a partial image at a crack position using the crack width information. FIG. 19A shows an example of an image 1920 captured using a given image capturing parameter, which indicates an image including a crack 1900 on the concrete wall surface. The crack 1900 is a crack having various crack widths in portions of one crack. FIG. 19A assumes that a local crack width can be measured with respect to the crack 1900. For example, FIG. 19A shows portions where crack widths such as 0.15 mm and 0.50 mm are apparent. These crack widths are input by the user via the operation unit 12 while capturing an image, by measuring the actual crack width on the concrete wall surface. Alternatively, the user may confirm the captured image, estimate the crack width, and input it via the operation unit 12 while capturing an image. The CPU 10 stores the input crack width in the image storage unit 1303 in association with the captured image. On the other hand, FIG. 19B shows an example of a reference image 1921, which indicates an image of the concrete wall surface including a crack 1910. Similar to the crack 1900, the crack 1910 is a crack having various crack widths in portions of one crack. With respect to the crack 1910 as well, a local crack width is recorded, and for example, crack widths such as 0.10 mm and 0.50 mm are recorded in FIG. 19B. The crack width information of the reference image is stored in the image storage unit 1303, and is called from the image storage unit 1303 together with the reference image 1921.

In calculation of the evaluation value between the captured image 1920 and the reference image 1921 in FIG. 19A, the estimation unit 1304 compares the edge intensities of the crack portions having the same crack width with each other. For example, as a portion having a crack width of 0.50 mm, the estimation unit 1304 calculates the similarity based on the edge intensity of a partial image 1901 of the captured image 1920 and that of a partial image 1911 of the reference image 1921. As a portion of a crack width of 0.10 mm, the estimation unit 1304 calculates the similarity based on the edge intensity of a partial image 1902 of the captured image 1920 and that of a partial image 1912 of the reference image 1921. In this way, based on the similarity between the partial images of the same crack width, an evaluation value s between the captured image 1920 and the reference image 1921 is given by:

$$s = {\sum }_{i} {α}_{i} {d}_{i} \qquad ( 9 )$$

where di represents the similarity between partial images of a given crack width (for example, a crack having a width of 0.10 mm), and αi represents a weight given to the evaluation value of the given crack width, which gives a larger weight to a smaller crack width. This calculates a higher evaluation value as the quality of a fine crack portion of the captured image has a higher degree of matching with respect to the quality of the reference image. Therefore, it is possible to adjust the image capturing condition by paying attention to the quality of the fine crack portion becoming close to the quality of the reference image.

Note that when calculating an evaluation value using the images of the crack portions, the image capturing resolution of the concrete wall surface is preferably the same between the captured image and the reference image. More specifically, processing of performing adjustment so that the concrete wall surface included in each of the captured image and the reference image has a resolution of, for example, 1.0 mm/pixel is performed in advance. This is because the appearance such as the edge intensity changes depending on the resolution even for the same crack. Performing tilt correction in advance so that the concrete wall surface faces forward in the image is also a preferable embodiment.

The embodiment of creating an image feature amount for each of the captured image and the reference image, calculating the similarity between the images based on the distance between the feature amounts or the like, and setting the similarity as an evaluation value has been explained above. The method of calculating the similarity between images is not limited to this, and an evaluation value may be calculated using a learning model learned in advance. In this method, a model that outputs a higher evaluation value as the similarity between an input image and a reference image is higher is learned in advance. In this learning, learning can be performed using a data set D given by:

D={(x₁,y₁,t₁), . . . ,(xₙ,yₙ,tₙ), . . . ,(x_{N},y_{N}t_{N}} (10)

where xₙ represents an arbitrary reference image, yₙ represents an arbitrary captured image, and tₙ represents supervised data that takes 1 when xₙ and yₙ are regarded as similar images and takes 0 when xₙ and yₙ are not regarded as similar images. Any learning method of performing learning using this data set may be used. For example, as an example of a learning method using a CNN (Convolutional Neural Network), there is provided a method described in NPL 1. In the method described in NPL 1, a model which has learned the data set D can calculate an evaluation value by inputting, to the model, a captured image and a reference image for which the evaluation value is to be calculated.

Various methods have been described above as the method of calculating the evaluation value between the captured image and the reference image. In addition to the above-described methods, various methods have conventionally been proposed as the method of calculating the similarity between images. The estimation unit 1304 may calculate the evaluation value of this embodiment using these known methods.

The plurality of evaluation value calculation methods have been described above. These evaluation value calculation methods may each be used individually or may be used in combination. If the plurality of methods are combined, the estimation unit 1304 calculates the final evaluation value s by, for example, the following equation.

$$s = {\sum }_{j} {α}_{j} {d}_{j} \qquad ( 11 )$$

where sj represents an evaluation value obtained by a given method and wj represents the weight of the method. In step S1606, the estimation unit 1304 calculates the evaluation value between the captured image and the reference image by the above method. In step S1606, the estimation unit 1304 calculates the evaluation value for each of the images captured using the plurality of image capturing parameters.

In step S1607, the estimation unit 1304 evaluates the image capturing parameter based on the evaluation value calculated in step S1606.

In step S1608, the estimation unit 1304 determines, based on the evaluation result, whether to readjust the image capturing parameter.

If the image capturing parameter is readjusted, the estimation unit 1304 estimates, in step S1609, a method of improving the image capturing parameter. Then, the estimation unit 1304 returns to the processing of capturing a plurality of images in step S1605.

If the image capturing parameter is not readjusted, the image capturing parameter setting unit 1305 sets, in step S1610, the image capturing parameter in the image capturing unit 1301. Then, the processing of the flowchart shown in FIG. 16 ends.

These processes will be described below.

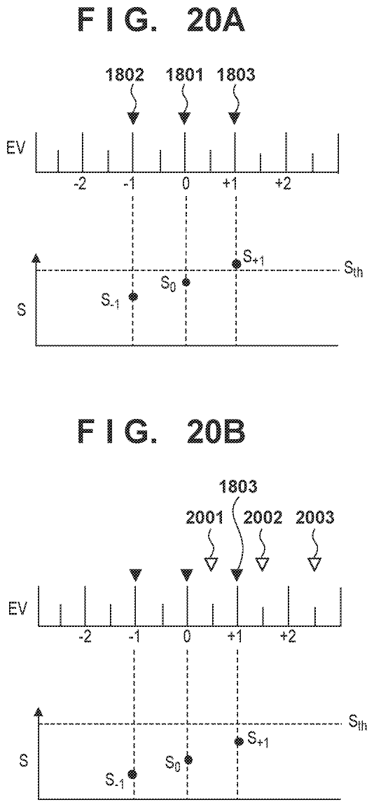

In the image capturing parameter evaluation processing in step S1607, the estimation unit 1304 selects a highest one of the evaluation values of the plurality of image capturing parameters, and compares it with the predetermined threshold. FIG. 20A is a view for explaining evaluation of each image capturing parameter. In this embodiment, three exposures (EV) are set as a plurality of image capturing parameters. In FIG. 20A, states in which EV−1, EV0, and EV+1 are set as the plurality of image capturing parameters are represented by the triangle 1801, a triangle 1802, and the triangle 1803, similar to FIG. 18A. The lower portion of FIG. 20A shows evaluation values s₋₁, s₀, and s₊₁ obtained from the reference image and the images captured using the respective image capturing parameters. In FIG. 20A, the evaluation value s₊₁ of the exposure 1803 of EV+1 is the highest evaluation value and exceeds a predetermined threshold sₜₕ. If there exists the image capturing parameter indicating the evaluation value exceeding the predetermined threshold sₜₕ, the estimation unit 1304 determines that the image capturing parameter is suitable as an image capturing parameter for an inspection image. In the case shown in FIG. 20A, the estimation unit 1304 selects the exposure 1803 of EV+1 as an optimum parameter. In step S1608, the estimation unit 1304 determines that it is unnecessary to readjust the image capturing parameter, and advances to step S1610 to set the image capturing parameter. In step S1610, the image capturing parameter setting unit 1305 sets the exposure of EV+1 in the image capturing unit 1301, and ends the processing shown in FIG. 16. FIG. 20B shows an example of setting the exposures of EV−1, EV0, and EV+1 as the plurality of image capturing parameters and calculating the evaluation values, similar to FIG. 20A, but shows a status in which the evaluation values different from those in FIG. 20A are obtained. In FIG. 20B, the evaluation value s₊₁ is the highest evaluation value but does not exceed the predetermined threshold sₜₕ. The images captured using these image capturing parameters each have low similarity with the reference image, and are thus not suitable as the image capturing parameter for an inspection image. In this case, the estimation unit 1304 determines in step S1608 that it is necessary to readjust the image capturing parameter, and advances to step S1609. In step S1609, the estimation unit 1304 estimates a method of improving the image capturing parameter.

The processing of estimating the image capturing parameter improving method will be described with reference to FIG. 20B. In FIG. 20B, the evaluation value s₊₁ of the exposure of EV+1 is lower than the threshold sₜₕ but is the highest evaluation value among the evaluation values s₋₁ to s₊₁. Therefore, in the processing of readjusting the image capturing parameter, the estimation unit 1304 sets a plurality of image capturing parameters from image capturing parameters around that image capturing parameter (the exposure of EV+1). For example, if three image capturing parameters are also set in the next image capturing adjustment processing, the estimation unit 1304 sets, as a plurality of parameters, exposures 2001, 2002, and 2003 around the exposure 1803 of EV+1, as shown in FIG. 20B. Then, the process returns to step S1605, and these image capturing parameters are set in the image capturing unit 1301 via the image capturing parameter setting unit 1305 to capture a plurality of images again. The estimation unit 1304 re-executes the processes (evaluation value calculation processing) in step S1606 and the subsequent steps of FIG. 16 to search for an optimum image capturing parameter. If the evaluation value equal to or higher than the threshold sₜₕ cannot be obtained even in evaluation of the image capturing parameter set, the estimation unit 1304 decides again a plurality of new image capturing parameters around the image capturing parameter indicating the highest evaluation value. Then, the estimation unit 1304 re-executes the image capturing processing. This loop is repeatedly executed until the image capturing parameter for which an evaluation value exceeding the threshold sₜₕ is obtained is decided. Note that the maximum repetition count may be decided in advance, and if no optimum image capturing parameter (no image capturing parameter for which an evaluation value equal to or higher than the threshold sₜₕ is obtained) is obtained before the maximum repetition count, the processing may be aborted. If the image capturing parameter adjustment processing is aborted, the estimation unit 1304 displays a warning on the operation unit 12 to notify the user that the image capturing parameter has not sufficiently been adjusted. Alternatively, the image capturing parameter for capturing the image, for which the highest evaluation value is calculated and which is obtained before the processing is aborted, may be set in the image capturing unit 1301 via the image capturing parameter setting unit 1305.

The embodiment in which only if no evaluation value equal to or higher than the threshold sₜₕ is obtained in step S1607, estimation of improved image capturing parameters and repetitive adjustment are performed has been explained above. However, even if the image capturing parameter indicating the evaluation value equal to or higher than the threshold sₜₕ is found, an image capturing parameter indicating a higher evaluation value may further be searched for. In this case, after setting, as improved image capturing parameters, image capturing parameters around the image capturing parameter indicating the highest evaluation value, the information processing apparatus 1300 captures a plurality of images again, and repeatedly executes the evaluation value calculation processing. As a condition for ending the repetitive processing, a predetermined repetition count is reached or the evaluation value remains unchanged even if the image capturing parameter is changed around the highest evaluation value.

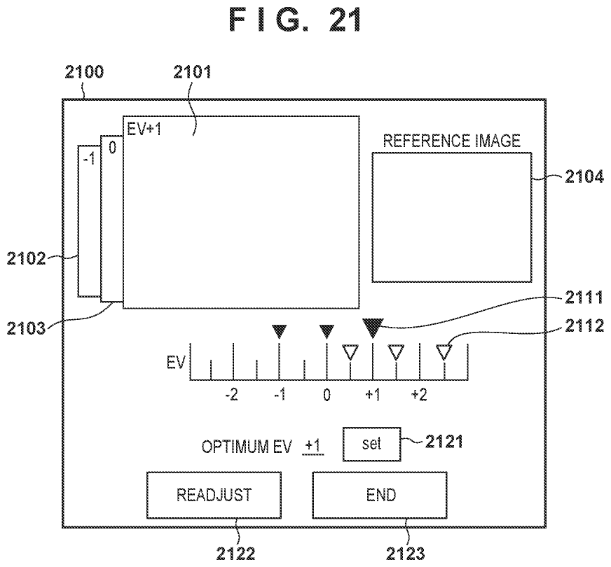

On the other hand, the user may confirm the image capturing parameter, and determine to end the repetitive processing for image capturing parameter adjustment. In this case, in step S1608 of FIG. 16, instead of determining the optimum image capturing parameter using the threshold sₜₕ of the evaluation value, the estimation unit 1304 determines, based on a user operation, whether to executes readjustment of the image capturing parameter. To do this, the estimation unit 1304 presents information necessary for the user on the operation unit 12, and accepts an input from the user via the operation unit 12. FIG. 21 is a view for explaining the operation unit 12 when adjusting the image capturing parameter based on user determination. The information presented to the user and the user operation will be described below with reference to FIG. 21.

The operation unit 12 shown in FIG. 21 is a display 2100 for displaying information. An image 2101 in a screen displayed on the operation unit 12 is an image captured using the image capturing parameter of the exposure of EV+1, and captured images 2102 and 2103 are images captured using other image capturing parameters. A reference image 2104 is also displayed on the display, and the user can perform confirmation by comparing the captured image with the reference image.

In a portion below the image 2101, the plurality of image capturing parameters set for image capturing parameter adjustment are shown. In FIG. 21, three exposures (EV) are indicated by black triangles as examples of the plurality of image capturing parameters. Among the black triangles, a black triangle 2111 indicating EV+1 that indicates the highest evaluation value is highlighted (displayed in a large size). A white triangle 2112 and the like indicate a plurality of image capturing parameter candidates that are set based on the image capturing parameter 2111 of EV+1 and used to further adjust the image capturing parameter.

In this embodiment, the user confirms these pieces of information displayed on the operation unit 12, and determines whether to adopt the current image capturing parameter or further execute the image capturing parameter adjustment processing. More specifically, the user compares the captured image with the reference image using the image 2101 for which the highest evaluation value is obtained. If the degree of matching is satisfactory, the user can determine to adopt the image capturing parameter indicating the highest evaluation value. If the user adopts the image capturing parameter indicating the highest evaluation value, an icon 2121 on which “set” is displayed is selected. This operation causes the image capturing parameter setting unit 1305 to set the image capturing parameter indicating the highest evaluation value in the image capturing unit 1301 (step S1610 of FIG. 16), thereby ending the image capturing parameter adjustment processing. On the other hand, if the image 2101 is confirmed and then the current optimum image capturing parameter is not satisfactory, the user selects an icon 2122 on which “readjustment” is displayed. This instruction re-executes the processes (evaluation value calculation processing) in step S1606 and the subsequent steps of FIG. 16 using the plurality of next image capturing parameters (for example, the exposure 2112 and the like). After that, the information processing apparatus 1300 presents again various kinds of information to the user, as shown in FIG. 21. The user determines, based on the presented information, whether to adopt the image capturing parameter or further adjust the image capturing parameter.

If the image capturing parameter adjustment processing is stopped halfway, an icon 2123 on which “end” is displayed is selected. This operation allows the information processing apparatus 1300 to end the image capturing parameter adjustment processing (the loop of the flowchart shown in FIG. 16). At this time, the information processing apparatus 1300 may set, among the evaluated image capturing parameters used for image capturing, the image capturing parameter whose evaluation value is highest in the image capturing unit 1301.

Note that even if it is determined by the user operation to continue the image capturing parameter adjustment processing, the threshold sₜₕ of the evaluation value may be preset, and it may be displayed that there exists the image capturing parameter for which the evaluation value exceeding the threshold sₜₕ is obtained. For example, if, in FIG. 21, an evaluation value s2111 of an image captured using the image capturing parameter 2111 exceeds the threshold sₜₕ, the information processing apparatus 1300 may perform flickering display of the black triangle 2111 indicating the image capturing parameter. The user can adopt the image capturing parameter regardless of the evaluation value. However, when the information processing apparatus 1300 displays the existence of the image capturing parameter exceeding the evaluation value, it is possible to assist determination of whether to adopt the image capturing parameter.

In the sixth embodiment, the embodiment of estimating the method of improving the image capturing parameter has been explained above. However, the image capturing method estimated by the method according to this embodiment is not limited to the image capturing parameter, and another image capturing method may be estimated. In an embodiment of estimating an image capturing method other than the image capturing parameter, if an evaluation value equal to or higher than the predetermined threshold is not obtained even by executing the loop of the processing procedure shown in FIG. 16 a plurality of times, the estimation unit 1304 further analyzes the image or the image capturing status, thereby proposing an appropriate image capturing method. For example, if it is determined that the brightness of the image is insufficient or it is determined that the white balance cannot be adjusted by the image capturing parameter, the estimation unit 1304 may make a notification to the user to change the illumination condition using illumination or capture an image at a time when it is light by changing the image capturing time. As another example, if it is possible to acquire the position and orientation of the image capturing unit 1301, the estimation unit 1304 analyzes the positional relationship with an inspection target structure, thereby proposing a position and orientation for improving image capturing. More specifically, for example, if an image is captured at the position and orientation at which the tilt angle with respect to the wall surface of the inspection target structure is large, the estimation unit 1304 recommends to the user to capture an image at the position and orientation at which the tilt angle is decreased.

### Seventh Embodiment

The sixth embodiment has explained the embodiment of selecting one image from the image storage unit 1303, setting it as a reference image, and then adjusting the image capturing method based on the one selected reference image. The seventh embodiment will describe an embodiment of adjusting an image capturing method using a plurality of reference images. Note that in subsequent embodiments, parts different from the sixth embodiment will mainly be explained.

In the seventh embodiment, a reference image processing unit 1302 selects a plurality of reference images. Assume that the reference image processing unit 1302 selects M reference images. The M reference images may be selected using any method. For example, upper M stored images of a search result may be set as the M reference images.

Next, an estimation unit 1304 calculates evaluation values between a captured image and the M reference images. In this processing, an evaluation value between the captured image and each reference image is calculated first. For example, the estimation unit 1304 calculates an evaluation value between the captured image and an mth reference image, and this evaluation value is represented by s^{m}. A method of calculating an evaluation value between a captured image and a reference image is similar to the method according to the sixth embodiment. If M evaluation values are obtained by the processing of calculating the evaluation values between the captured image and the M reference images, the estimation unit 1304 calculates a final evaluation value s by averaging the evaluation values.

$$s = \frac{1}{M} {\sum }_{m} {s}^{m} \qquad ( 12 )$$

In subsequent processing, a CPU 10 adjusts an image capturing parameter based on the evaluation value s (executes processes in step S1607 and subsequent steps of FIG. 16 in the sixth embodiment). By using the average of the evaluation values s^{m}, the image capturing parameter is adjusted so as to capture an image similar as a whole to the plurality of reference images.

As another form of using a plurality of reference images, there is provided a method of adjusting an image capturing parameter based on an evaluation value with respect to one most similar reference image among the plurality of reference images. In this case, the final evaluation value s between the captured image and the M reference images is given by:

s=max([s¹, . . . ,s^{m}, . . . ,s^{M}]) (13)

This method adjusts the image capturing parameter so as to capture an image similar to one of the M reference images. Since the M reference images are images of preferable image quality, the captured image need only be similar to one of the reference images.

### Eighth Embodiment

The above-described embodiments assume that a reference image is an image obtained by capturing a structure different from an image capturing target structure. However, a past image of the image capturing target structure may be set as a reference image. In infrastructure inspection, a past inspection result and a latest inspection result are compared to each other. To perform this comparison, a past image and a latest image are preferably captured with the same image quality. If there exists a past image of the image capturing target structure, it is possible to adjust the image capturing parameter so as to capture an image similar to the past image by setting the past image as a reference image.

To set the past image as the reference image, an image storage unit 1303 according to the eighth embodiment stores the past image of the image capturing target structure. A reference image processing unit 1302 performs processing of acquiring the past image from the image storage unit 1303 based on information of the image capturing target structure, and setting the past image as the reference image. To do this, the reference image processing unit 1302 according to the eighth embodiment may be able to search for the stored image in the image storage unit 1303 using unique information such as the name of the structure. With respect to processing after setting the past image of the image capturing target structure as the reference image, the same processing as in the sixth embodiment is performed, thereby making it possible to adjust the image capturing method. With the above arrangement, it is possible to adjust the image capturing parameter so as to obtain an image capturing result similar to the past image.

If the past image is set as the reference image, the image capturing range of the reference image and that of the captured image are preferably made match each other. In this case, an image capturing position and an image capturing range are adjusted so as to capture, in this image capturing operation, the same range as that captured in the past image set as the reference image with respect to the image capturing target structure. To support adjustment of the image capturing position and range, information of the image capturing position and image capturing range may be saved in association with the past image stored in the image storage unit 1303. If the image capturing range of the reference image (past image) and that of the captured image match each other, the reciprocal of the sum of squared errors between pixels of the past image and captured image may be used as an evaluation value calculation method. In fact, since it is extremely difficult to match the past image capturing operation and the current image capturing operation at the pixel level, a similarity calculation method that allows a positional shift to some extent is preferably used.

If the past image includes a variation of a concrete wall surface, an evaluation value may be calculated based on a variation portion in the image. In this case, an estimation unit 1304 captures the same portion as the variation portion of the past image, and calculates a higher evaluation value as a variation in the captured image is more similar to the variation in the past image. This makes it possible to adjust the image capturing parameter so as to confirm, in the captured image as well, the variation included in the past image. Furthermore, the estimation unit 1304 may calculate an evaluation value between the past image and the captured image in consideration of aging of the variation. For example, a case in which the variation included in the past image is a crack will be explained. A crack recorded in past inspection never disappears naturally unless it undergoes a repair work. On the other hand, the crack may extend due to aging. Therefore, if the crack in the captured image is compared with that in the past image, the estimation unit 1304 does not use an image of the extended portion of the crack in the captured image to calculate the similarity of the crack portion.

### Ninth Embodiment

The embodiment in which the reference image processing unit 1302 of each of the above-described embodiments searches for an image stored in the image storage unit 1303 and sets it as a reference image has been described. The ninth embodiment will describe an embodiment in which a reference image processing unit 1302 generates an image and the generated image is set as a reference image.

In recent years, in a learning-based method, noise removal and super-resolution of an image have progressed. For example, NPL 2 describes a noise removal technique of an image using an autoencoder. In this technique, a noise removal model is learned by learning an autoencoder using an image with noise and an image without noise. When a noise image on which noise removal is to be performed is input to the noise removal model, an image from which noise has been removed is obtained as an output. NPL 3 describes an image super-resolution technique by a Fully CNN. In this technique, a super-resolution model is learned by learning a Fully CNN using a low-resolution image and a high-resolution image. When a low-resolution image whose resolution is to be increased is input to the super-resolution model, a high-resolution image is obtained as an output. These techniques are techniques of obtaining a transformation model of an image by learning. In the ninth embodiment, a reference image is generated from a temporarily captured image using these techniques. Note that the noise removal technique and the super-resolution technique have been exemplified but a technique used in the ninth embodiment is not limited to the techniques described in NPL 2 and NPL 3 and any technique may be used as long as image transformation can be performed.

FIG. 22 is a block diagram showing an example of the arrangement of an information processing apparatus 1300 according to the ninth embodiment. The information processing apparatus 1300 according to the ninth embodiment has an arrangement including a model storage unit 1306 instead of the image storage unit 1303 unlike FIG. 14 (sixth embodiment). The model storage unit 1306 stores a model for generating a reference image. This model will be referred to as a reference image generation model hereinafter. The reference image generation model is a model that obtains an image transformation method by learning using the technique described in NPL 2 or 3. The reference image generation model is learned using, for example, a learning data set D given by:

D={((x₁,y₁), . . . ,(xₙ,yₙ), . . . ,(x_{N},y_{N}))} (14)

where xₙ represents an image captured in a state in which adjustment of an image capturing parameter is insufficient. yₙ corresponding to xₙ represents an image obtained by capturing the same image capturing target using a preferable image capturing parameter. Using the learning data set D, learning of a reference image generation model F is given by:

$$F = {argmin}_{F} {\sum }_{n}^{N} ‖ F ( {x}_{n} ) - {y}_{n} ‖ \qquad ( 15 )$$

A portion of F(xₙ)−yₙ represents an error between the image yₙ and an image obtained by transforming the image xₙ using the reference image generation model F. Therefore, with respect to N data of the data set D, a reference whose error is smallest learns the reference image generation model F.

If an image obtained using an image capturing parameter that has not been adjusted is input to the learned reference image generation model F, an image (generated image) captured using the preferable image capturing parameter is output. However, since the generated image is a false image generated by the reference image generation model F, there is a risk to directly use the image as an inspection image or the like. For example, the generated image may include small artifacts along with image generation processing although this depends on the performance of the reference image generation model. Therefore, in this embodiment, the generated image is used as not an image capturing result but a reference for image capturing parameter adjustment.

The model storage unit 1306 stores the thus learned reference image generation model F. Note that in recent years, a method called GAN (Generative Adversarial Nets), as described in NPL 4, has developed as a method of learning an image generation model. This method may be used to learn the reference image generation model F.

Reference image creation processing using the image generation model F will be described next. First, the user temporarily captures the image capturing target using an image capturing unit 1301. Assume that an image capturing parameter for temporary image capturing is set using automatic setting or the like, and a temporarily captured image is an image obtained when image capturing parameter adjustment is insufficient to capture the image capturing target. The reference image processing unit 1302 creates a generated image by inputting the temporarily captured image to the image generation model F read out from the model storage unit 1306, and sets the generated image as a reference image for image capturing parameter adjustment.

The generated image is created using the temporarily captured image. However, the generated image may be created by additionally using information of the image capturing target. For example, as a method, the reference image generation model F is learned for each condition, for example, for each structure type of the image capturing target or each concrete type. The plurality of reference image generation models are stored in the model storage unit 1306 together with the pieces of information of the learning conditions. In a step of creating a reference image, the user designates the condition of the image capturing target (for example, the structure type of the image capturing target) to call the reference image generation model matching the condition from the model storage unit 1306, and uses it for image generation. This can create the generated image using the reference image generation model suitable for the image capturing target.

Another embodiment of creating a generated image using information of the image capturing target will be described next. In this embodiment, in addition to the model storage unit 1306, an image storage unit 1303 is provided like the sixth embodiment. Similar to the sixth embodiment, the image storage unit 1303 stores an ideal image capturing result image of the image capturing target. The user selects an image similar to the condition of the image capturing target from the image storage unit 1303. The operation of selecting an image from the image storage unit 1303 can be performed by searching the image storage unit 1303 based on the information of the image capturing target, similar to reference image selection in the sixth embodiment. In this embodiment, the image selected from the image storage unit 1303 will be referred to as a style image hereinafter. Then, the appearance of the temporarily captured image is transformed into an image similar to the style image using, for example, the technique described in NPL 5. NPL 5 describes a technique in which if an original image and a style image are input, the style of the image can be transformed by a technique of transforming the appearance of the original image into an image similar to the style of the style image. In this embodiment, it is possible to make the appearance of the temporarily captured image similar to the style image by setting the temporarily captured image to the original image of NPL 5, thereby creating an ideal image capturing result image. The thus created image is used as a reference image. According to this embodiment, it becomes easy to generate an image similar to the image capturing target by selecting the style image from the image storage unit 1303 using the information of the image capturing target.

As described above, in the ninth embodiment, the image generated by the reference image processing unit 1302 is set as a reference image. Subsequent processing is performed similar to the sixth embodiment, thereby making it possible to adjust an image capturing parameter for capturing an image similar to the reference image.

The ninth embodiment will also explain an embodiment of abolishing a plurality of image capturing parameter setting operations and a plurality of image capturing operations (steps S1604 and S1605 of FIG. 16) and adjusting the image capturing parameter from the reference image and one captured image.

In the ninth embodiment, one image of the image capturing target is captured using a given initial parameter. Processing (S1606) of calculating an evaluation value by comparison with the reference image is executed on the one image. If the calculated evaluation value is equal to or higher than a threshold, processing (steps S1607, S1608, and S1610 of FIG. 16) of ending parameter setting is performed.

Processing different from the arrangement using the plurality of image capturing parameters according to the sixth embodiment is step S1609 in which if the evaluation value is equal to or lower than the threshold, a method of improving the image capturing parameter is estimated. In the ninth embodiment, an improved image capturing parameter is estimated by a statistical technique from one given evaluation value and an image capturing parameter at this time. Therefore, in the ninth embodiment, the relationship between the evaluation value and the improved image capturing parameter is learned in advance. This relationship can be learned using, for example, the following data.

X=[(s₁,p₁), . . . ,(sₙ,pₙ), . . . ,(s_{N},p_{N})]^{T} (16)

Y=[p_{dst_1}, . . . ,p_{dst_n}, . . . ,p=_{dst_N}]^{T} (17)

In equation (16), pₙ represents an image capturing parameter, and sₙ represents an evaluation value obtained from an image captured using pₙ. Assume that sₙ is an evaluation value equal to or lower than the threshold. In equation (17), p_{dst_n} represents an image capturing parameter when the evaluation value finally becomes equal to or higher than the threshold by adjusting the image capturing parameter from the state of (sₙ, pₙ). Learning data (X, Y) is created by collecting n sets of these data. When an evaluation value s lower than the given threshold and an image capturing parameter p are input, a model E that outputs an improved parameter p_{dst} is learned using the learning data.

p_{dst}=E(s,p) (18)

Any algorithm can be used to learn this model. If, for example, the image capturing parameter is a continuous value, a regression model of linear recurrence or the like can be applied.

The embodiment of learning the model that calculates the improved parameter p_{dst} by receiving the evaluation value s and the image capturing parameter p has been described above. However, information of the captured image may be input to this model. The information of the captured image is, for example, the feature amount of the entire image, more specifically, the luminance histogram of the entire image or the like. The information of the captured image is not limited to this, and may be a partial feature amount of the image, or the image may be input to the model. By inputting the image information to the model, as descried above, it is possible to estimate the improved parameter p_{dst} based on the captured image in addition to the evaluation value and the image capturing parameter.

When the model E prepared in advance as described above is used for the improved parameter estimation processing in step S1609, it is possible to estimate the improved image capturing parameter from one image in the ninth embodiment.

Note that as a method of obtaining the improved image capturing parameter, the arrangement using the learned model may be used in the method of capturing images using a plurality of image capturing parameters according to the sixth embodiment. That is, the model E is not limited to the arrangement of estimating the image capturing parameter from one image, and may be used in the method of estimating an image capturing parameter from a plurality of images. In this case, the model E is learned, which calculates evaluation values from the reference image and images captured using a plurality of image capturing parameters, similar to the sixth embodiment, and obtains an improved parameter by inputting the plurality of image capturing parameters and the plurality of evaluation values. Learning data X for learning this model M is rewritten from equation (16) to an equation below when the number of images captured in image capturing parameter adjustment is represented by M.

X=[(s₁₁,p₁₁, . . . ,s₁ₘ,p₁ₘ, . . . ,s_{1M},p_{1M}), . . . ,(sₙ₁,pₙ₁, . . . ,sₙₘ,pₙₘ, . . . ,s_{NM},p_{NM}),]^{T} (19)

Note that an objective variable (or supervised data) Y is the same as that give by equation (17).

### 10th Embodiment

The ninth embodiment has explained the embodiment of generating the reference image from the temporarily captured image using the reference image generation model. The reference image generation model is not limited to the ninth embodiment, and an embodiment of using the reference image generation model to generate a reference image from a stored image may be possible. The 10th embodiment will describe an embodiment of transforming an image stored in advance in an image storage unit 1303 to create a reference image. In the sixth embodiment, an image stored in the image storage unit 1303 is selected and set as the reference image. However, in the 10th embodiment, a selected stored image is transformed in accordance with an image capturing condition, and is then set as a reference image. This embodiment will be described below.

The image storage unit 1303 stores a number of stored images of various image capturing conditions but it is difficult to prepare an image matching all the image capturing conditions. To cope with this, a stored image is transformed and adjusted to generate a new image in accordance with an image capturing condition, and the generated image is set as a reference image. For example, a case in which a camera model as an image capturing condition is different will be described. Assume that the stored images are constituted by only images captured by a camera (to be referred to as camera A hereinafter) of a specific model. On the other hand, assume that a camera for capturing an image capturing target is a camera (to be referred to as camera B hereinafter) of a model different from camera A. Since the models of cameras A and B are different from each other, the image qualities of captured images are also different from each other. For example, since the tint and the like of image capturing quality are different for each camera model, even if the same target is captured in the same status by cameras A and B, images different in image quality such as tint are obtained.

In the 10th embodiment, in this case, the stored image of quality of camera A is transformed into an image of quality of camera B using a reference image generation model, and then the transformed image is set as a reference image. The reference image generation model in this case is, for example, a transformation parameter for transforming the tint of camera A into that of camera B. With respect to processing after the reference image is set, the same processing as in the sixth embodiment is performed, thereby making it possible to adjust an image capturing parameter for matching quality with the quality of the reference image.

Processing for performing such processing will be described next. An information processing apparatus according to this embodiment additionally includes a model storage unit in an information processing apparatus 1300 shown in FIG. 14, and the model storage unit stores reference image generation models corresponding image capturing conditions. In the first processing, a reference image processing unit 1302 searches for a stored image similar to the image capturing target from an image storage unit, and acquires it, similar to the sixth embodiment. In the 10th embodiment, the stored image of the search result is set as a temporary reference image. In the next processing, the reference image processing unit 1302 prepares, based on an image capturing condition, a reference image generation model for transforming the temporary reference image into a reference image. In the above-described example, the reference image processing unit 1302 sets the camera model (camera B) as an image capturing condition to read out, from the model storage unit, the reference image generation model including the transformation parameter for transforming the tint of camera A into that of camera B. To do this, the user inputs information of the image capturing condition via an operation unit 12. Alternatively, information of the image capturing condition such as the camera model that can automatically be acquired may automatically be acquired, and then used to search for the reference image generation model. In the next processing, the reference image processing unit 1302 transforms the temporary reference image using the reference image generation model, thereby creating a reference image.

In the above-described example, the embodiment of using the camera model as the image capturing condition, selecting the reference image generation model based on the image capturing condition, and transforming a temporarily captured image to generate a reference image has been described. The image capturing condition for generating a reference image is not limited to the camera model, and another condition may be used. For example, the weather may be set as the image capturing condition. In this case, assuming that the stored image (temporary reference image) selected as an image similar to the image capturing target is an image captured when the weather is fine, and the weather is cloudy when capturing the image capturing target, the reference image generation model that transforms the quality (tint or brightness) of the image captured when the weather is fine into that of the image captured when the weather is cloudy is selected from the model storage unit. The image capturing conditions may include an image capturing time and an image capturing season. Furthermore, a condition such as handheld capturing, tripod capturing, or image capturing by a camera mounted on a moving body such as a drone may be set as an image capturing condition. Such image capturing condition may be a combination of a plurality of conditions. For example, in the image capturing condition of “camera B, cloudy”, an image generation model that transforms a temporary reference image of “camera A, fine” into quality of “camera B, cloudy” may be selected.

The parameter for transforming an image has been exemplified as the image generation model. However, the image generation model according to the 10th embodiment is not limited to this, and may be a model based on learning, as described in the ninth embodiment. In this case, for example, an image generation model is learned for each image capturing condition for transforming an image, and the image generation model is then selected and used in accordance with the image capturing condition. The image generation model can be learned, similar to the ninth embodiment, using a data set of a group of images before transformation and a group of preferable images after transformation.

In the ninth and 10th embodiments, the reference image processing unit 1302 displays the generated reference image on the operation unit 12 to allow the user to confirm the reference image. If the user determines that the reference image is not suitable as a reference for adjusting the image capturing parameter, it may be possible to generate another reference image again. In this case, candidates of the reference image generation model may be displayed so as to reselect the reference image generation model for generating another reference image, or the reference image generation model may be searched for again. Furthermore, if the methods according to the ninth and 10th embodiments are used at the same time, the user may be able to select whether to use the reference image (the reference image generated by the method according to the ninth embodiment) obtained by transforming the temporarily captured image or the reference image (the reference image generated by the method according to the 10th embodiment) obtained by transforming the temporary reference image. In this case, the reference image processing unit 1302 displays, on the operation unit 12, the reference image obtained by transforming the temporarily captured image and the reference image obtained by transforming the temporary reference image to be compared to each other, and the user can select the reference image suitable as a reference for image capturing parameter adjustment.

### 11th Embodiment

The above embodiment has explained the embodiment of applying an information processing apparatus 1300 of this embodiment to capturing of an inspection image of an infrastructure. The information processing apparatus 1300 of this embodiment is not limited to capturing of an inspection image, and can be applied to image capturing parameter adjustment for another image capturing target. The 11th embodiment will describe an embodiment of applying the above-described processing and the like to image capturing parameter adjustment in general photography.

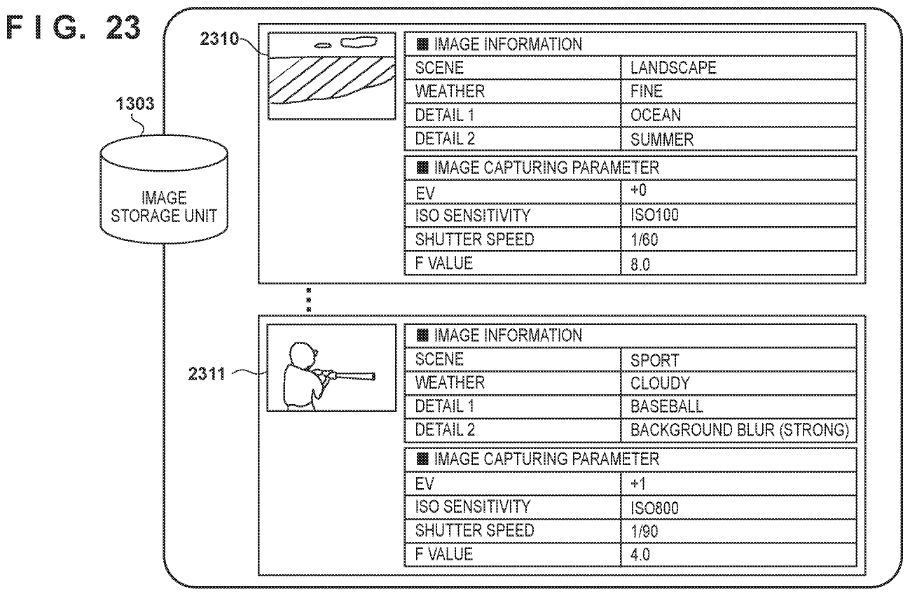

In this embodiment, to apply the above-described processing and the like to general photography, images stored in an image storage unit 1303 of the sixth embodiment are changed. FIG. 23 is a view for explaining information stored in the image storage unit 1303 according to the 11th embodiment. The image storage unit 1303 shown in FIG. 23 stores stored images, image information, and image capturing parameters, similar to FIG. 15. A stored image 2310 shown in FIG. 23 is a landscape photograph of the sea, and information such as scene: landscape, weather: fine, detail 1: sea, and detail 2: summer is recorded as image information of the stored image. A stored image 2311 is a baseball image, and image information indicating image contents is stored in association with the stored image.

In this embodiment as well, similar to the sixth embodiment, a reference image is selected from the image storage unit 1303 based on information of an image capturing target to be captured by the user. The user selects the scene type of the image capturing target, the weather, and other information, or inputs a keyword. The reference image processing unit 1302 searches for the image information stored in the image storage unit 1303 based on the information input by the user, and selects the stored image suitable as a reference image. In selecting the reference image, similar to the sixth embodiment, reference image candidates may be presented to the user and the user may select the image determined as an optimum image and set it as the reference image, or the uppermost image of the search result may automatically be set as the reference image. Furthermore, similar to the sixth embodiment, a temporarily captured image is captured, and then a reference image may be searched for from the image storage unit 1303 based on the temporarily captured image.

The above processing can select a reference image as a reference for adjustment of the image capturing parameter of a captured image even in general photography. As processing after setting the reference image, an evaluation value between the captured image and the reference image is calculated and image capturing parameter adjustment is executed, similar to the above-described embodiments. In the above description of the embodiment of general photography, the embodiment of applying the above-described arrangement and the like to general photography by changing the stored images in the image storage unit 1303 has been explained. As the embodiment of applying the above-described arrangement and the like to general photography, an arrangement of generating a reference image using a reference image generation model may be adopted, similar to the ninth embodiment.

Although the embodiments of the present invention have been described in detail above, the present invention is not limited to any specific embodiments.

The information processing apparatus 1300 according to each of the above-described embodiments can readily set an image capturing parameter for capturing a desired image without confirming details of a captured image.

According to the present invention, it is possible to estimate an image capturing method suitable for capturing an image capturing target without requiring the user to confirm a captured image.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
an acquisition unit configured to acquire reference data from a storage unit;
an evaluation unit configured to evaluate, using the reference data acquired from the storage unit and each of a plurality of captured images obtained by capturing an image capturing target by each of a plurality of image capturing methods by an image capturing unit, appropriateness of each of the plurality of captured images as an execution target of processing of detecting a predetermined target from an image by a detection unit; and
an estimation unit configured to estimate an image capturing method suitable for capturing the image capturing target based on an evaluation result of the evaluation unit.

2. The information processing apparatus according to claim 1, wherein the evaluation unit acquires a higher evaluation value as the appropriateness of each of the plurality of captured images as the execution target of the processing of detecting the predetermined target from the image by the detection unit is higher.

3. The information processing apparatus according to claim 1, wherein the image capturing method is an image capturing parameter set in the image capturing unit.

4. The information processing apparatus according to claim 3, wherein the evaluation unit acquires a higher evaluation value as the image capturing parameter set in the image capturing unit is more suitable as a parameter for capturing the execution target of the processing of detecting the predetermined target.

5. The information processing apparatus according to claim 1, wherein
the reference data is a reference image,
the evaluation unit evaluates the appropriateness of each of the plurality of captured images from the reference image and the plurality of captured images obtained by capturing, a plurality of times, the image capturing target by the image capturing unit in which each of a plurality of image capturing parameters is set, and
the estimation unit estimates, based on the evaluation result, the image capturing method suitable for capturing the image capturing target.

6. The information processing apparatus according to claim 5, wherein the reference image is an image obtained by capturing the image capturing target in the past.

7. The information processing apparatus according to claim 6, further comprising an image storage unit, as the storage unit, configured to store stored images as candidates of the reference image and pieces of image information of the stored images,
wherein the acquisition unit selects and acquires, based on a search condition, the reference image from the stored images stored in the image storage unit.

8. The information processing apparatus according to claim 7, wherein based on the search condition, the acquisition unit selects a plurality of reference image candidates from the stored images stored in the image storage unit, displays the selected reference image candidates on an operation unit, and selects the reference image based on a user operation via the operation unit.

9. The information processing apparatus according to claim 5, wherein the evaluation unit acquires an evaluation value as similarity between the reference image and each of the plurality of captured images.

10. The information processing apparatus according to claim 9, wherein if the evaluation value does not exceed a threshold even by adjusting the image capturing parameter set in the image capturing unit, the estimation unit estimates, as the image capturing method, one of an image capturing position and orientation, an image capturing time, and an illumination condition.

11. The information processing apparatus according to claim 5, wherein
the acquisition unit acquires a plurality of reference images, and
the evaluation unit performs evaluation from the plurality of reference images and the plurality of captured images.

12. The information processing apparatus according to claim 7, wherein
the image capturing target is a concrete wall surface of an infrastructure, and
the image information includes at least one of a structure type of the image capturing target, a concrete type, weather at the time of image capturing, a target in an image, an installation location and region of the structure, and the number of elapsed years.

13. The information processing apparatus according to claim 5, further comprising a generation unit configured to generate, using a model learned in advance, the reference image from a temporarily captured image obtained by capturing the image capturing target.

14. The information processing apparatus according to claim 5, further comprising a generation unit configured to generate, using a model learned in advance, the reference image from a stored image and an image capturing condition of the image capturing target.

15. The information processing apparatus according to claim 1, wherein
the reference data is past information of the target in at least a partial image capturing range of the image capturing target,
the information processing apparatus further comprises a detection unit configured to detect the target from the plurality of captured images obtained by capturing, a plurality of times, the image capturing range by the image capturing unit in which each of the plurality of image capturing parameters is set,
the evaluation unit evaluates the appropriateness of each of the plurality of captured images from the past information of the target and a detection result of the detection unit with respect to the plurality of captured images, and
the estimation unit estimates the image capturing method suitable for capturing the target based on the evaluation result.

16. The information processing apparatus according to claim 15, further comprising a setting unit configured to set the plurality of image capturing parameters in the image capturing unit,
wherein the setting unit sets a past image capturing parameter as an initial parameter and sets the plurality of image capturing parameters based on the initial parameter.

17. The information processing apparatus according to claim 15, wherein when the detection result matches past data or when the detection result is a larger region including the past data, the evaluation unit acquires an evaluation value which is higher than a value acquired when the detection result does not match the past data or when the detection result is not a larger region.

18. The information processing apparatus according to claim 17, wherein the estimation unit excludes a region in which aging of the image capturing range is large, and then acquires the evaluation value based on the detection result of the detection unit and the past data.

19. The information processing apparatus according to claim 1, wherein the target is a variation of a wall surface of an inspection target structure.

20. The information processing apparatus according to claim 19, wherein the variation is a crack on a concrete wall surface.
